(19) United States
(12) Patent Application Publication
(10) Pub. No.: US 2015/0127318 A1
(43) Pub. Date: May 7, 2015

(54) APPARATUS AND METHOD FOR SIMULATING AN OPERATION OF AN OUT-OF-ORDER PROCESSOR

(71) Applicant: Fujitsu Limited, Kawasaki-shi (JP)

(72) Inventors: David Thach, Meguro (JP); Shinya Kuwamura, Kawasaki (JP); Atsushi Ike, Minato (JP)

(73) Assignee: Fujitsu Limited, Kawasaki (JP)

(21) Appl. No.: 14/496,760

(22) Filed: Sep. 25, 2014

(30) Foreign Application Priority Data
Nov. 1, 2013 (JP) 2013-228805

(51) Int. Cl. G06F 17/50

(52) U.S. Cl. CPC G06F 17/5009
USPC 703/17

(57) ABSTRACT

An operation of a processor with out-of-order execution is simulated by a computer configured to access a storage unit storing a specific internal state of the processor. A program executed by the processor is divided into a plurality of blocks. When a target block on which an operation simulation is to be performed is changed from a first block to a second block in the plurality of blocks, the computer determines whether the second block is a block that performs a process according to an exception that has occurred in the first block. When it is determined that the second block is a block that performs the process according to the exception, the computer performs the operation simulation of the second block after changing an internal state of the processor in the operation simulation to the specific internal state stored in the storage unit.

### CROSS-REFERENCE TO RELATED APPLICATION

This application is based upon and claims the benefit of priority of the prior Japanese Patent Application No. 2013-228805, filed on Nov. 1, 2013, the entire contents of which are incorporated herein by reference.

### FIELD

The embodiment discussed herein is related to apparatus and method for simulating an operation of an out-of-order processor.

### BACKGROUND

Currently, in order to support development of programs, a technique for estimating performance, such as execution time of a program, at a time when the program operates on a processor is used.

In addition, currently, there is a technique for performing a simulation for each instruction in the case of an operation whose delay may be calculated and performing a logical simulation for each cycle in the case of an operation whose delay is difficult to calculate, such as cache access (for example, refer to Japanese Laid-open Patent Publication No. 2011-81623).

### SUMMARY

According to an aspect of the invention, an apparatus simulate an operation of a processor with out-of-order execution, where the apparatus is configured to access a storage unit storing a specific internal state of the processor. The apparatus divides a program executed by the processor into a plurality of blocks. When a target block on which an operation simulation is to be performed is changed from a first block to a second block in the plurality of blocks, the apparatus determines whether the second block is a block that performs a process according to an exception that has occurred in the first block. When it is determined that the second block is a block that performs the process according to the exception, the apparatus performs the operation simulation of the second block after changing an internal state of the processor in the operation simulation to the specific internal state stored in the storage unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a simulation method, according to an embodiment;

FIG. 2 is a diagram illustrating an example of a change in a target block after occurrence of an exception, according to an embodiment;

FIG. 3 is a diagram illustrating an example of a block in which an exception process is performed;

FIG. 4 is a diagram illustrating an example of a block in which an exception routine is performed;

FIG. 5 is a diagram illustrating an example of a hardware configuration of a simulation apparatus, according to an embodiment;

FIG. 6 is a diagram illustrating an example of a functional configuration of a simulation apparatus, according to an embodiment;

FIG. 7 is a diagram illustrating an example of information stored in a host code list, according to an embodiment;

FIGS. 8A and 8B are diagrams illustrating an example of incorporation of timing codes, according to an embodiment;

FIG. 9 is a diagram illustrating an example of target codes;

FIG. 10 is a diagram illustrating an example of a host code;

FIG. 11 is a diagram illustrating an example of an internal state after a pipeline flush, according to an embodiment;

FIG. 12 is a diagram illustrating an example of a configuration of a target central processing unit (CPU), according to an embodiment;

FIGS. 13 to 20 are diagrams illustrating an example of changes in the internal state of a target CPU, according to an embodiment;

FIG. 21 is a diagram illustrating an example of a performance value table, according to an embodiment;

FIG. 22 is a diagram illustrating an example of a relationship between generation of host codes and correspondence information, according to an embodiment;

FIG. 23 is a diagram illustrating an example of a processing operation performed by a correction unit, according to an embodiment;

FIGS. 24A to 24C are first diagrams illustrating an example of correction performed on a result of execution of an Id instruction, according to an embodiment;

FIGS. 25A to 25C are second diagrams illustrating an example of correction performed on results of execution of Id instructions, according to an embodiment;

FIGS. 26A to 26C are third diagrams illustrating an example of correction performed on results of execution of Id instructions, according to an embodiment;

FIGS. 27 to 29 are diagrams illustrating an example of an operational flowchart for a simulation process performed by a simulation apparatus, according to an embodiment;

FIG. 30 is a diagram illustrating an example of an operational flowchart for a process of executing host codes, according to an embodiment; and

FIG. 31 is a diagram illustrating an example of an operational flowchart for a correction process performed by a correction unit, according to an embodiment.

### DESCRIPTION OF EMBODIMENT

In the case of a processor with out-of-order execution, however, performance when the processor has executed blocks obtained by dividing the program varies depending on an execution situation. Therefore, it might be difficult to accurately estimate the performance at a time when the processor has executed the program.

In the case of a processor with out-of-order execution, the performance of the processor during execution of blocks is different depending on an execution situation because the order of instructions changes among the blocks from that indicated by the program. Therefore, when the execution order indicated by the program and the execution order actually adopted by the processor with out-of-order execution are different from each other, it might be difficult to accurately estimate the performance.

Therefore, for example, the simulation apparatus may accurately estimate the performance by executing, based on an internal state of the processor after an operation simulation of a previous target block, an operation simulation at a time when the processor executes a target block. The internal state of the processor refers to states of modules that are included in the processor in order to realize out-of-order execution. In an actual processor adopting a pipeline scheme, however, pipelines are flushed immediately before execution of a block in which a process according to an exception is performed. The flush of the pipelines indicates initialization of the pipelines. Here, a flush of the pipelines will also be referred to as a pipeline flush. For this reason, if it is assumed that the processor executes a target block based on the internal state thereof after an operation simulation of a previous target block, it is difficult to accurately estimate the performance. Therefore, in this embodiment, the simulation apparatus executes an operation simulation at a time when the processor has executed a target block after the internal state of the processor in the operation simulation is changed to a state in which the processor has been subjected to a pipeline flush. As a result, the accuracy of estimating the performance improves.

A simulation method, a simulation program, and a simulation apparatus according to an embodiment will be described in detail hereinafter with reference to the accompanying drawings.

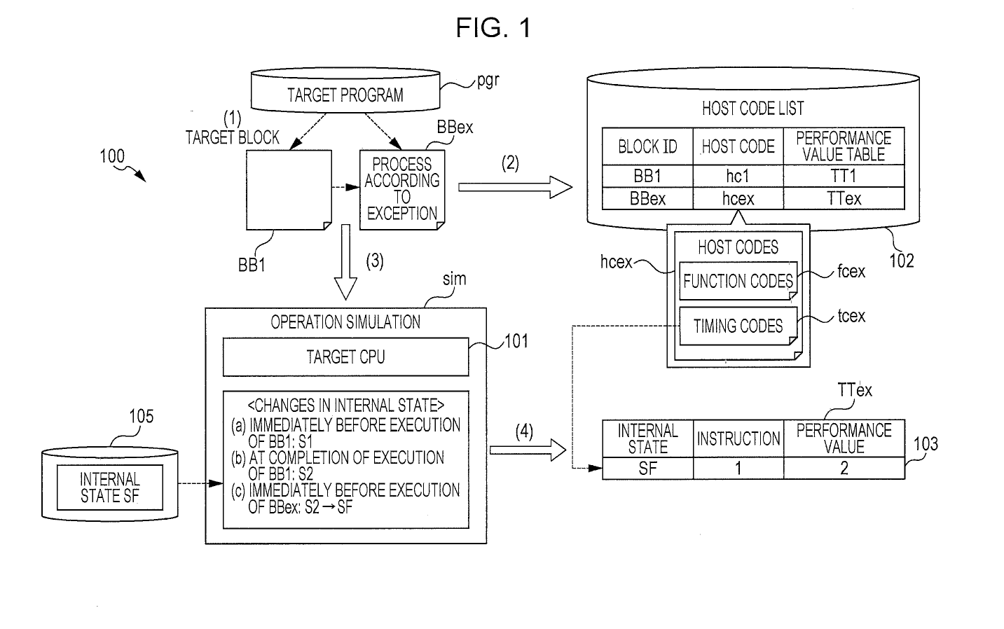

FIG. 1 is a diagram illustrating an example of a simulation method, according to an embodiment. A simulation apparatus 100 is a computer that executes a performance simulation in which a performance value of a target program at a time when a first processor with out-of-order execution has executed the program is calculated. The performance value may be, for example, execution time or the number of cycles. The simulation apparatus 100 includes a second processor, which is different from the first processor, and a storage unit 105 storing a specific internal state SF of the first processor. Here, the first processor will be also referred to as a target central processing unit (CPU) 101, and the second processor will be also referred to as a host CPU. In this embodiment, for example, the target CPU 101 is based on an ARM (registered trademark) architecture, and the host CPU is based on an x86 architecture. The specific internal state SF may be, for example, a state in which the target CPU 101 has been subjected to a pipeline flush.
(1) The simulation apparatus 100 detects a change in, among blocks obtained by dividing a program, a target block of an operation simulation sim from a first block to a second block at a time when the target CPU 101 executes the program. The simulation apparatus 100 then determines, when the target block has changed from the first block to the second block, whether the second block is a block that performs the process according to an exception that has occurred in the first block. In the example illustrated in FIG. 1, the first block is a block BB1, and the second block is a block BBex. Here, the exception is an abnormal event that makes it difficult to continue executing a program. A process according to an exception will also be referred to as an exception process. An exception may be, for example, division by zero.

For example, the simulation apparatus 100 may determine whether the second block is a block that performs the process according to an exception in accordance with whether an exception has occurred while executing execution codes corresponding to the first block. Here, the execution codes are codes that may calculate, based on correspondence information in which internal states and performance values are associated with each other, a performance value at a time when the target CPU 101 executes the second block. The execution codes will be referred to as host codes hc herein. For example, the simulation apparatus 100 may determine whether an exception has occurred by executing the host codes hc corresponding to the first block in a kernel executed by the host CPU.
(2) The simulation apparatus 100 determines whether the second block became a target block of a simulation in the past. For example, when the simulation apparatus 100 has determined that the second block was not a target block in the past, the simulation apparatus 100 generates host codes hc corresponding to the second block. As described above, the host codes hc are codes that include codes that are able to calculate, based on the correspondence information in which internal states and performance values are associated with each other, the performance value at a time when the target CPU 101 executes the block. The host codes hc include function codes fc obtained by compiling the block and timing codes tc that is able to calculate, based on the correspondence information, the performance value at a time when the target CPU 101 executes the block. For example, host codes hcex corresponding to the block BBex include function codes fcex and timing codes tcex. For example, the generated host codes hcex are stored in a host code list 102.
(3) When the simulation apparatus 100 has determined that the second block is a block that performs the process according to an exception, the simulation apparatus 100 changes the internal state of the target CPU 101 in the operation simulation sim to the specific internal state SF stored in the storage unit 105. For example, in the example illustrated in FIG. 1, (a) the internal state of the target CPU 101 immediately before execution of the block BB1 is S1, and (b) the internal state of the target CPU 101 after the operation simulation sim of the block BB1 is S2. Although the internal state of the target CPU 101 immediately before execution of the block BBex is S2, (c) the simulation apparatus 100 changes the internal state of the target CPU 101 in the operation simulation sim to the specific internal state SF stored in the storage unit 105. Next, (4) by executing the operation simulation sim of the second block after making the change, the simulation apparatus 100 generates correspondence information 103 in which the specific internal state SF and performance values of instructions included in the second block in the specific internal state SF are associated with each other. The generated correspondence information 103 is stored in a performance value table TTex corresponding to the block BBex.

Here, the second block includes an instruction to cause the target CPU 101 to access a storage region. A detailed example of the second block will be described later. Here, the storage region is, for example, a main memory. For example, the instruction to cause the target CPU 101 to access the storage region may be a load instruction to read data from the main memory or the like or a store instruction to write data to the main memory or the like. For example, when the load instruction or the store instruction is executed, the target CPU 101 accesses a cache memory, such as a data cache, an instruction cache, or a translation lookaside buffer (TLB). The cache memory includes a control unit and a storage unit. The control unit has a function of determining whether data that is to be accessed and is indicated by the access instruction is stored in the storage unit. Here, when the data to be accessed is stored in the storage unit, the event is called a “cache hit”, and when the data to be accessed is not stored in the storage unit, the event is called a “cache miss”. Whether a cache miss or a cache hit occurs depends on the storage state of the cache memory. Therefore, the simulation apparatus 100 estimates the performance values of instructions included in the second block through the operation simulation sim, based on the premise that a result of the operation of the cache memory is either a cache miss or a cache hit. The timing codes tc include codes capable of performing an operation simulation of the cache memory when the target CPU 101 executes the target CPU 101 and correcting the performance value when a result of the operation simulation of the cache memory is different from a result of the operation simulation sim.

By executing the host codes hcex using the specific internal state SF and the correspondence information 103 generated for the second block, the simulation apparatus 100 calculates the performance value of the second block at a time when the target CPU 101 executes the second block. As a result, the performance value is corrected when the result of the operation of the cache memory in the operation simulation of the cache memory is different from the result of the operation of the cache memory in the operation simulation sim. Therefore, the accuracy of estimating the performance value of the block improves.

Thus, according to the simulation apparatus 100, the accuracy of estimating the performance value of a block that performs the process according to an exception improves. In addition, since the internal state at the beginning of the operation simulation sim of the block that performs the process according to an exception remains the same, it is sufficient that the correspondence information regarding the block that performs the process according to an exception be generated only once. As a result, the amount of memory is reduced.

### Example of Change in Target Block after Occurrence of Exception

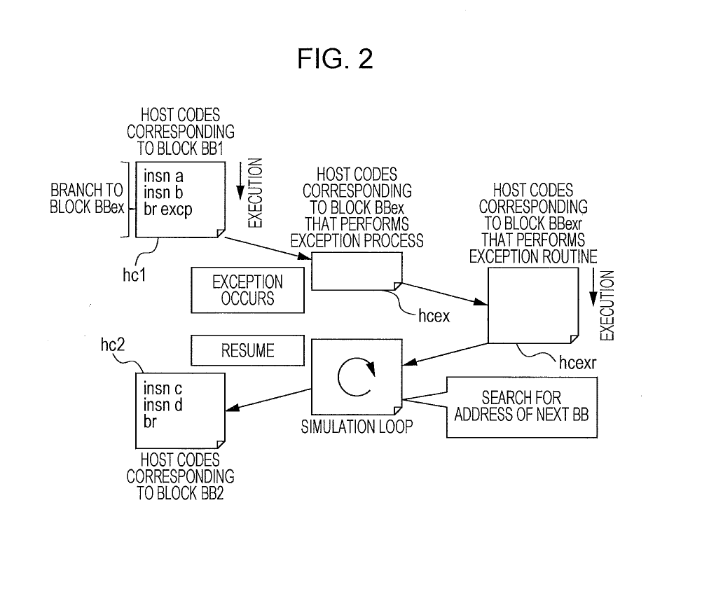

Here, a change in the target block after occurrence of an exception will be briefly described with reference to FIG. 2.

FIG. 2 is a diagram illustrating an example of a change in a target block after occurrence of an exception, according to an embodiment. For example, when an exception has occurred in the host codes hc1 corresponding to the block BB1, a branch instruction to branch to the block BBex, which performs the process according to the exception, is executed. As a result, the target block of the operation simulation sim changes from the block BB1 to the block BBex, which performs the process according to the exception. In addition, when an exception has occurred, the simulation apparatus 100 generates a program exception signal. For example, the simulation apparatus 100 changes the value of the program exception signal from 0 to 1.

Next, the simulation apparatus 100 determines a block BBexr, which performs an exception routine, as the target block of the simulation. The simulation apparatus 100 then returns the target block of the simulation to a block BB2, which would have performed a subsequent process if the exception had not occurred in the block BB1, by executing host codes hcexr corresponding to the block BBexr. As a result, the simulation apparatus 100 executes host codes hc2 corresponding to the block BB2.

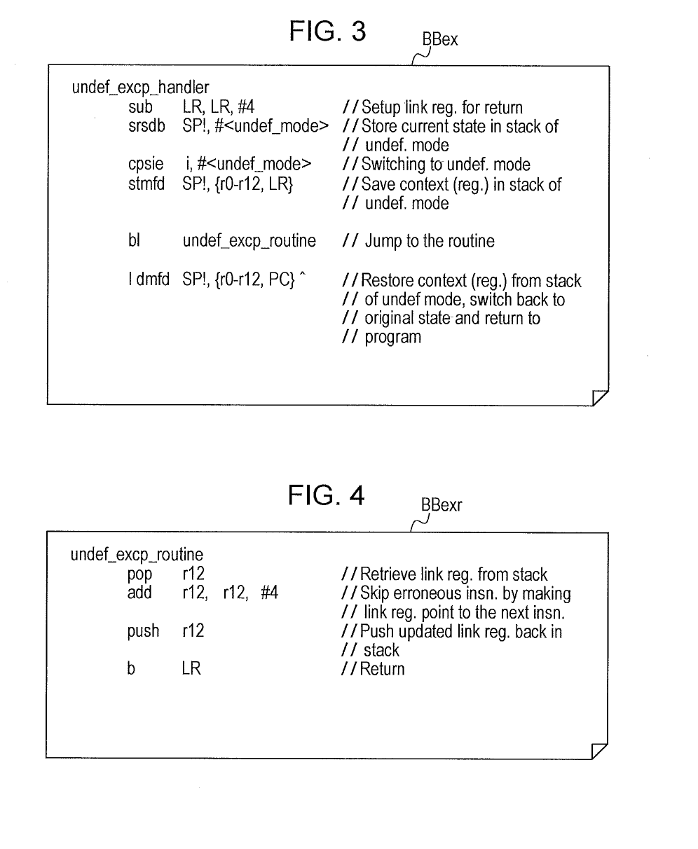

FIG. 3 is a diagram illustrating an example of a block that performs the exception process. FIG. 4 is a diagram illustrating an example of a block that performs the exception routine. In the example illustrated in FIG. 3, for example, the exception process in which an undefined instruction is executed is also referred to as an exception handler. The simulation apparatus 100 saves the current state to a stack region for an undefined mode. In the exception handler, an exception mode of the host CPU is set at the undefined mode. Next, in the exception handler, a context including an address for recovery is pushed to the stack region for the undefined mode, and the process branches to a block that performs the exception routine. In addition, as illustrated in FIG. 4, in the exception routine, a value of a register is popped from the stack region for the undefined mode and changed in such a way as to point to a first instruction of a block that would have performed a subsequent process if an exception had not occurred. Next, in the exception routine, the value of the register after the change is pushed to the stack region for the undefined mode, and the process returns to the original process.

As illustrated in FIG. 3, when the exception routine has ended, the exception handler pops the context including the address for recovery from the stack region for the undefined mode. As a result, the process returns to the block that would have performed a subsequence process if the exception had not occurred. For example, Idmfd indicates a load instruction, and stmfd indicates a store instruction. Therefore, as described with reference to FIG. 1, when performing the operation simulation sim, the simulation apparatus 100 assumes, for each of the generated load instruction and store instruction, that the result of the operation of the cache memory is either a cache hit or a cache miss.

### Example of Hardware Configuration of Simulation Apparatus 100

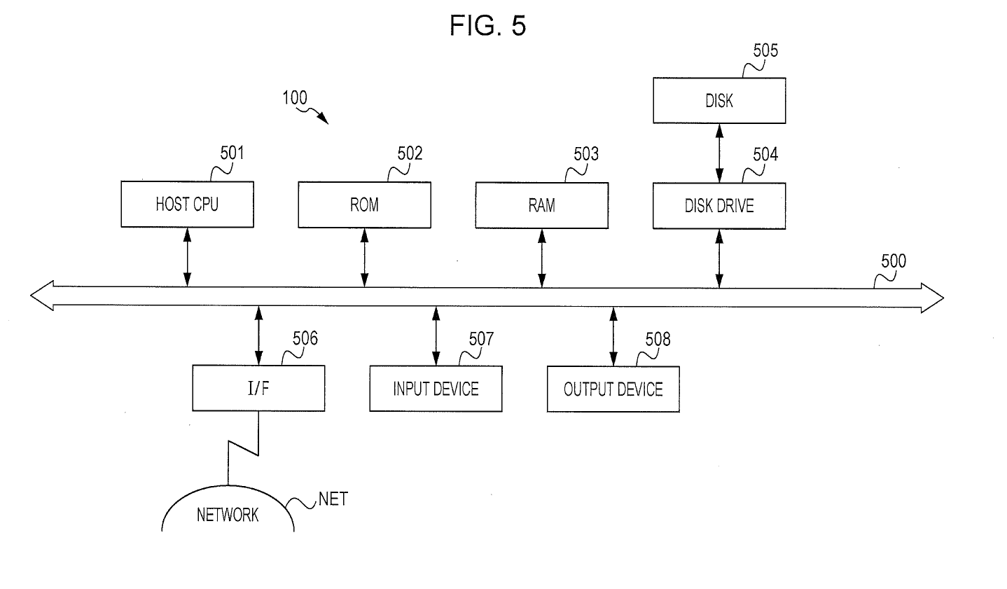

FIG. 5 is a diagram illustrating an example of a hardware configuration of a simulation apparatus, according to an embodiment. In FIG. 5, the simulation apparatus 100 includes a host CPU 501, a read-only memory (ROM) 502, a random-access memory (RAM) 503, a disk drive 504, and a disk 505. The simulation apparatus 100 includes an interface (I/F) 506, an input device 507, and an output device 508. These components are connected to one another by a bus 500.

Here, the host CPU 501 controls the entirety of the simulation apparatus 100. In addition, the host CPU 501 executes a performance simulation of the target CPU 101. The ROM 502 stores programs such as a boot program. The RAM 503 is a storage unit used as a working area of the host CPU 501. The disk drive 504 controls reading and writing of data from and to the disk 505 in accordance with the control performed by the host CPU 501. The disk 505 stores the data written as a result of the control performed by the disk drive 504. The disk 505 may be a magnetic disk, an optical disk, or the like. In addition, for example, the ROM 502 or the disk 505 is the storage unit 105, which stores the specific internal state SF.

The I/F 506 is connected to a network NET, such as a local area network (LAN), a wide area network (WAN), or the Internet through a communication line, and to other computers through the network NET. The I/F 506 is an interface between the network NET and the inside of the simulation apparatus 100 and controls inputting and outputting of data from and to the other computers. For example, a modem, a LAN adapter, or the like may be adopted as the I/F 506.

The input device 507 is an interface that inputs various pieces of data as a result of an input operation performed by a user using a keyboard, a mouse, a touch panel, or the like. The output device 508 is an interface that outputs data in accordance with an instruction from the host CPU 501. The output device 508 may be a display, a printer, or the like.

### Example of Functional Configuration of Simulation Apparatus 100

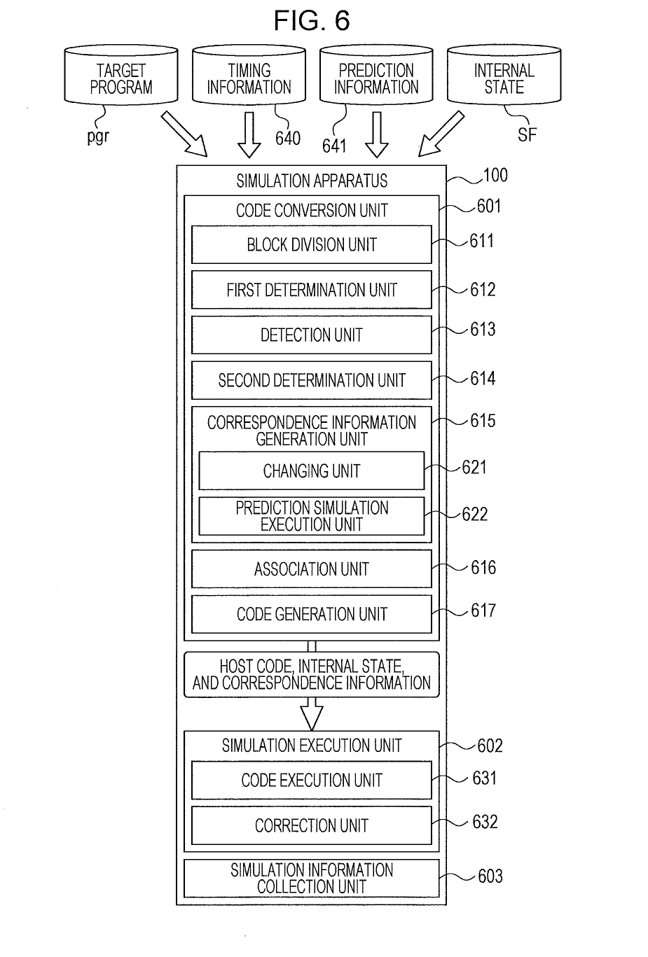

FIG. 6 is a diagram illustrating an example of a functional configuration of a simulation apparatus, according to an embodiment. The simulation apparatus 100 includes a code conversion unit 601, a simulation execution unit 602, and a simulation information collection unit 603. The code conversion unit 601, the simulation execution unit 602, and the simulation information collection unit 603 are functions that serve as control units. Processes performed by these units are, for example, coded in a simulation program stored in a storage device that may be accessed by the host CPU 501. The host CPU 501 reads the simulation program from the storage device and executes the processes coded in the simulation program. As a result, the processes performed by these units are realized. Results of the processes performed by these units are, for example, stored in a storage device such as the RAM 503 or the disk 505.

Here, the simulation apparatus 100 receives a target program pgr, timing information 640 regarding the target program pgr, prediction information 641, and the internal state SF. More specifically, for example, the simulation apparatus 100 receives the target program pgr, the timing information 640, the prediction information 641, and the internal state SF as a result of operations input by the user using the input device 507 illustrated in FIG. 5.

The target program pgr is a program whose performance is to be evaluated and may be executed by the target CPU 101. The simulation apparatus 100 estimates a performance value at a time when the target CPU 101 executes the target program pgr. The performance value may be, for example, execution time. The execution time is indicated, for example, by the number of cycles. In addition, the timing information 640 indicates a reference value of a performance value at a time when each of instructions included in the target program pgr has been executed and penalty time (the number of penalty cycles), which defines delay time according to a result of execution for each externally dependent instruction. An externally dependent instruction is an instruction whose performance value changes depending on the state of a hardware resource accessed by the target CPU 101 when the instruction is executed.

For example, an externally dependent instruction may be an instruction whose result of execution changes depending on the state of the instruction cache, the data cache, the TLB, or the like, such as a load instruction or a store instruction, or may be an instruction to perform a process such as branch prediction or stacking of calls and returns. In addition, the timing information 640 may include, for example, information indicating correspondences between processing elements (stages) and available registers when each instruction of a target code is executed. Here, a load instruction will also be referred to as an “Id instruction” hereinafter.

The prediction information 641 defines a likely result (predicted result) of execution of a process realized by each externally dependent instruction included in the target program pgr. The prediction information 641 defines, for example, “instruction cache: prediction=hit, data cache: prediction=hit, TLB search: prediction=hit, branch prediction: prediction=hit, call/return: prediction=hit, . . . ” or the like.

The internal state SF indicates a specific internal state, that is, the internal state of the host CPU at a time when the pipelines of the host CPU have been flushed. The internal state SF is created, for example, by an operation performed by the user based on the design specifications of the target CPU. As described above, for example, the simulation apparatus 100 receives the internal state SF as a result of an operation input by the user using the input device 507 illustrated in FIG. 5.

The code conversion unit 601 generates, when the target program pgr is executed, host codes hc that may be executed by the host CPU and correspondence information specified by the host codes hc, from the target program pgr executed by the target CPU 101. The code conversion unit 601 includes a block division unit 611, a first determination unit 612, a detection unit 613, a second determination unit 614, a correspondence information generation unit 615, an association unit 616, and a code generation unit 617.

The block division unit 611 divides the target program pgr into predetermined blocks BB. More specifically, for example, the block division unit 611 divides the target program pgr into the predetermined blocks BB by delimiting the target program pgr with a branch instruction, a resultant branch of the branch instruction, and an instruction to specify a process in which an exception might occur. As described above, an exception is an abnormal event that makes it difficult to continue executing a program. As described above, a process executed after occurrence of an exception in accordance with the content of the exception is referred to as an exception process. A process in which an exception might occur may be division by zero.

The block division unit 611 may divide the target program pgr into the blocks BB in advance, or may divide the target program pgr into the blocks BB when generating the host codes hc from the target program pgr.

The first determination unit 612 determines, when the target block of the operation simulation sim has changed from the first block to the second block, whether the second block is a block that performs the process according to an exception that has occurred in the first block. For example, the first determination unit 612 analyzes the procedure of execution of the host codes hc by a code execution unit 631 to determine whether an exception has occurred. Upon determining that an exception has occurred, the first determination unit 612 determines that the second block is a block that performs the process according to the exception.

When the target block has been changed from the first block to the second block, the second determination unit 614 determines whether the second block was a target block in the past. More specifically, by determining whether the second block has been compiled, the second determination unit 614 determines whether the second block was a target block in the past. More specifically, by determining whether the second block has been registered to the host code list 102, which will be described later, the second determination unit 614 determines whether the second block was a target block in the past. For example, when the second block has been registered to the host code list 102, the second determination unit 614 determines that the second block was a target block in the past. In addition, for example, when the second block has not been registered to the host code list 102, the second determination unit 614 determines that the second block was not a target block in the past.

When the second determination unit 614 has determined that the second block was not a target block in the past, the code generation unit 617 generates the host codes hc. More specifically, for example, the code generation unit 617 generates function codes fc that may be executed by the host CPU 501 by compiling the target block. Furthermore, the code generation unit 617 generates timing codes tc that is able to calculate, based on the internal state and the correspondence information, a performance value at a time when the target CPU 101 executes the target block, and then generates the host codes hc by incorporating the timing codes tc into the function codes fc. In addition, when the block division unit 611 has divided the target program pgr using an instruction to specify a process in which an exception might occur, the code generation unit 617 adds, to an end of the host codes hc, description of an instruction to branch to a block that performs the process according to an exception when the exception occurs.

More specifically, the code generation unit 617 obtains the performance value of the Id instruction in a predicted case of a “hit”, and generates the host codes hc that perform a process for obtaining a performance value at a time when a result of cache access by the Id instruction is a “miss” through correction calculation using addition to or subtraction from a performance value in the case of the “hit”, which is the predicted case. As a result, the host codes hc that is able to calculate the performance value at a time when the target CPU 101 executes the target block may be generated.

When the second determination unit 614 has determined that the second block was a target block in the past, the code generation unit 617 does not generate the host codes hc.

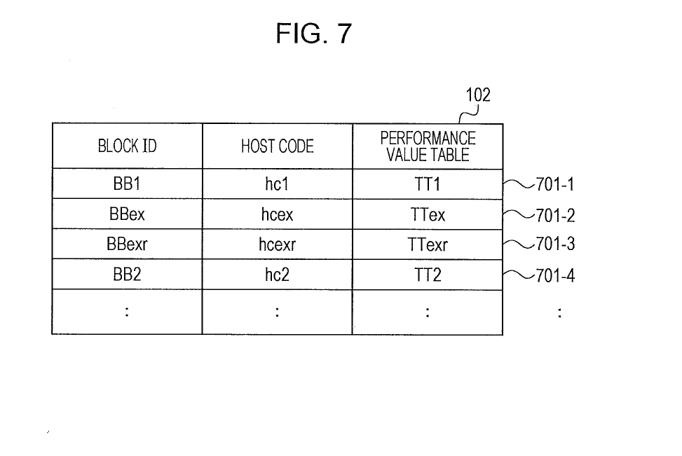

In addition, for example, the code generation unit 617 records the generated host codes hc of the target block, in the host code list 102, in association with a block identifier (ID) for identifying the target block (refer to FIG. 7). Here, information stored in the host code list 102 will be described. The host code list 102 is realized, for example, by a storage device such as the RAM 503 or the disk 505 illustrated in FIG. 5 or the like.

FIG. 7 is a diagram illustrating an example of information stored in a host code list, according to an embodiment. In FIG. 7, the host code list 102 stores block IDs, host codes hc, and performance value tables TT in association with each other. Here, the block IDs are identifiers of the blocks BB obtained by dividing a target code. The host codes hc are host codes hc of the blocks BB. The performance value tables TT are tables including correspondence information generated in accordance with the internal state for the blocks BB. The performance value tables TT may instead be associated in description of the host codes hc, but here the performance value tables TT are listed as the information stored in the host code list 102, in order to facilitate understanding. Pieces of information in fields of the host code list 102 are stored as records (701-1 to 701-4 and the like).

For example, the host code list 102 stores the host codes hc1 corresponding to the block BB1 and a performance value table TT1 corresponding to the block BB1 in association with each other. In addition, the host code list 102 stores the host codes hcex corresponding to the block BBex and a performance value table TTex corresponding to the block BBex in association with each. The specific examples of the performance value table TT will be described later.

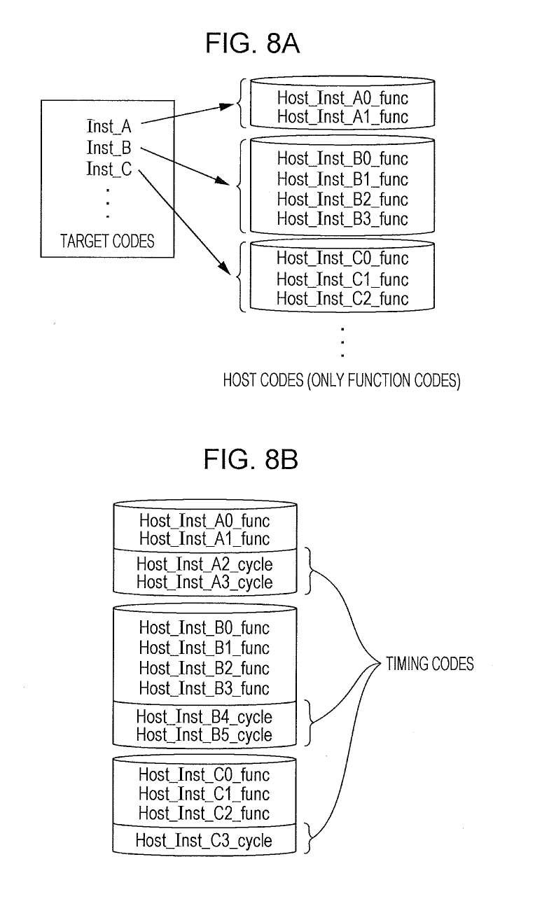

FIGS. 8A and 8B are diagrams illustrating an example of incorporation of timing codes, according to an embodiment. FIG. 8A illustrates an example in which host codes hc (including only function codes fc) are generated from target codes included in the target program pgr, and FIG. 8B illustrates an example of incorporation of timing codes tc into the host codes hc (including only the function codes fc).

As illustrated in FIG. 8A, a target code Inst_A is converted into host codes Host_Inst_A0_func and Host_Inst_A1_func; a target code Inst_B is converted into host codes Host_Inst_B0_func, Host_Inst_B1_func, Host_Inst_B2_func, and Host_Inst_B3_func; and so an, thereby generating the host codes hc including only the function codes fc.

Furthermore, as illustrated in FIG. 8C, timing codes Host_Inst_A2_cycle and Host_Inst_A3_cycle of the target code Inst_A, timing codes Host_Inst_B4_cycle and Host_Inst_B5_cycle of the target code Inst_B; and timing codes Host_Inst_C3_cycle of the target code Inst_C are incorporated into the host codes hc including only the function codes fc.

The timing codes tc are codes for expressing the performance values of instructions included in a target block as constants and obtaining the performance value of the target block by summing the performance values of the instructions. As a result, information indicating the progress of execution of the block may be obtained. Among the host codes hc, the function codes fc and the timing codes tc for instructions other than externally dependent instructions may be realized by using known codes. Timing codes tc for the externally dependent instructions are prepared as helper function call instructions for calling a correction process. The helper function call instructions will be described later.

### Example of Target Code Included in Target Program pgr

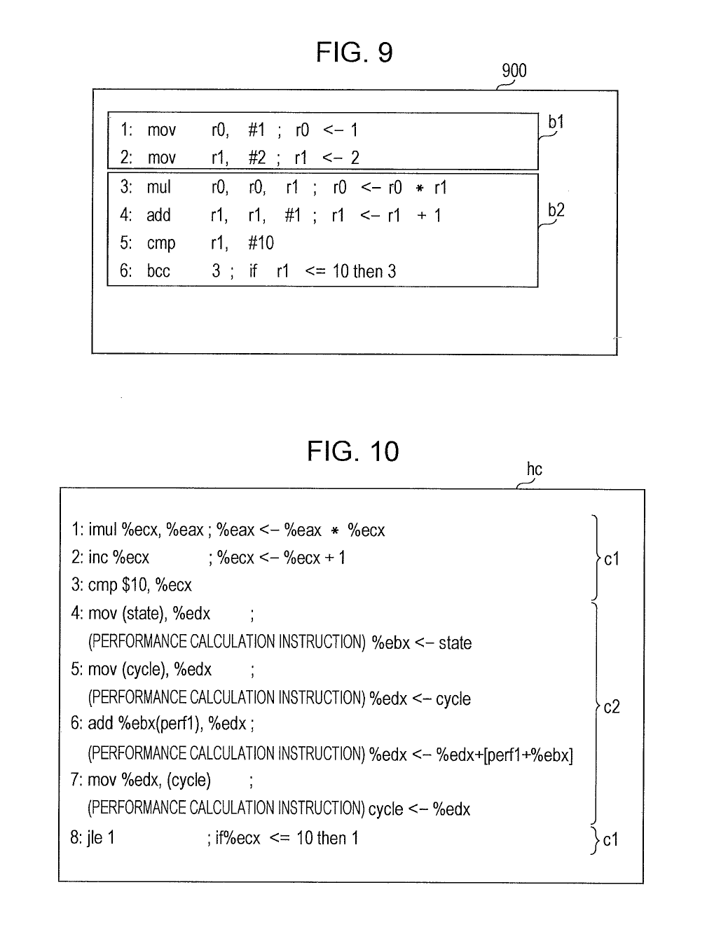

FIG. 9 is a diagram illustrating an example of a target code. In FIG. 9, a target code 900 is included in the target program pgr and obtains the product of 1×2×3×4×5×6×7×8×9×10 through a loop process. In the target code 900, first and second rows are blocks BB for an initialization process of the loop process. Third to sixth rows are blocks BB for a main body of the loop process. Here, it is assumed that the third to sixth rows constitute a target block b2 and the first and second rows constitute a target block b1 which has been immediately executed before the target block b2.

In the initialization process, an initial value of r0 is set at 1, and an initial value of r1 is set at 2. “mov r0, #1” is an instruction to set the initial value of r0 at 1, and “mov r1, #2” is an instruction to set the initial value of r1 at 2. The loop itself is a loop process in which the value of r1 continues to be incremented with the value of r0 set at “r0*r1” until the value of r1 reaches 10. “mul r0, r0, r1” is an instruction to set the value of r0 at “r0*r1”. “add r1, r1, #1” is an instruction to increment the value of r1 by one. “cmp r1, #10” is an instruction to determine whether the value of r1 is larger than 10. “bcc 3” is an instruction to branch to the instruction in the third row when the value of r1 is smaller than or equal to 10. As a result, the product of 1×2×3×4×5×6×7×8×9×10 is obtained.

FIG. 10 is a diagram illustrating an example of a host code, according to an embodiment. An example in which the host code hc is an x86 instruction is illustrated. The host code hc includes a function code c1 obtained by compiling the target program pgr and a timing code c2. The function code c1 corresponds to first to third rows and an eighth row of the host code hc. The timing code c2 corresponds to fourth to seventh rows of the host code hc. “state” in the host code hc is an index (internal state A=0, B=1, . . . ) of the internal state of the target CPU 101, and “perf1” indicates an address at which a performance value of Instruction 1 has been stored. When the host code hc as described above is executed, the performance value of each instruction is obtained from the correspondence information by using a detected internal state as an argument.

Next, when the second determination unit 614 determines that the second block was not a target block in the past and when the first determination unit 612 determines that the second block is a block that performs the process according to an exception, the correspondence information generation unit 615 illustrated in FIG. 6 generates correspondence information. Here, the correspondence information generation unit 615 executes the operation simulation sim of the second block after changing the internal state of the target CPU 101 in the operation simulation sim to the specific internal state SF stored in the storage unit 105. As a result, the correspondence information generation unit 615 generates correspondence information in which the specific internal state SF and the performance values of instructions included in the second block in the specific internal state SF are associated with each other. The specific internal state SF is a state in which the processor has been subjected to a pipeline flush.

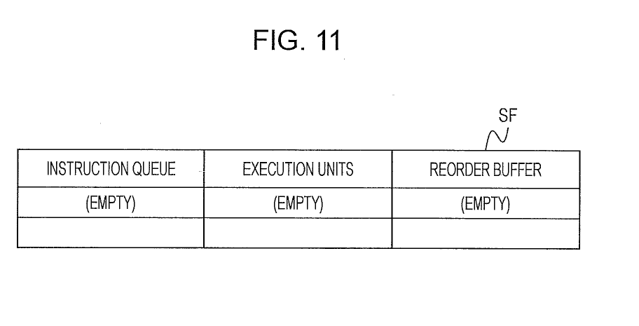

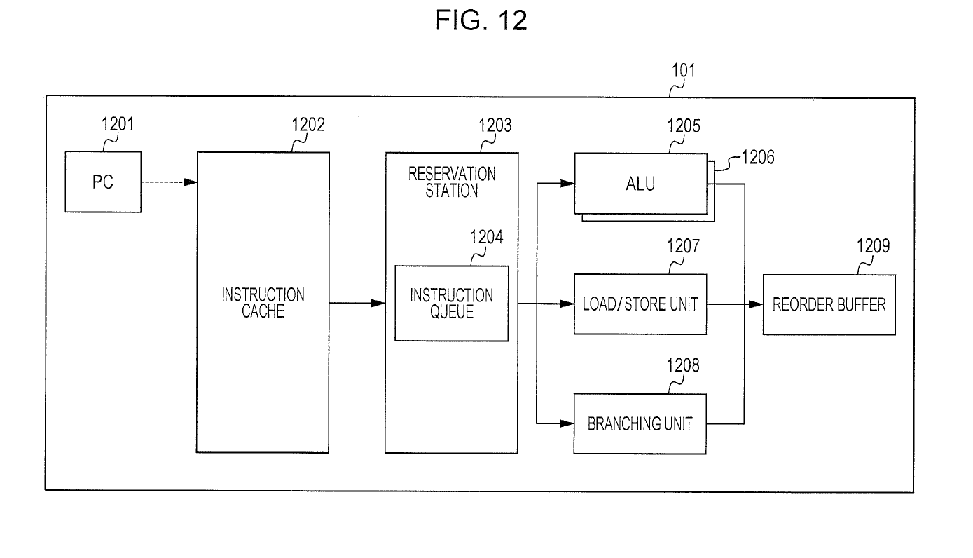

FIG. 11 is a diagram illustrating an example of an internal state after a pipeline flush, according to an embodiment. Here, as the internal state of the target CPU 101, an instruction stored in an instruction queue 1204 illustrated in FIG. 12, an instruction input to execution units (arithmetic and logic unit (ALUs) 1205 and 1206, a load/store unit 1207, and a branching unit 1208) illustrated in FIG. 12, and an instruction stored in a reorder buffer 1209 illustrated in FIG. 12 are illustrated. The internal state SF is a state in which the instruction queue 1204 and the reorder buffer 1209 illustrated in FIG. 12 are empty and no instruction has been input to the execution units illustrated in FIG. 12.

More specifically, the correspondence information generation unit 615 illustrated in FIG. 6 includes a changing unit 621 and a prediction simulation execution unit 622. When the second determination unit 614 determines that the second block was not a target block in the past and when the first determination unit 612 determines that the second block is a block that performs the process according to an exception, the changing unit 621 changes the internal state of the target CPU 101 in the operation simulation to the specific internal state SF. As described above, the specific internal state SF is stored in the storage unit 105. Next, the prediction simulation execution unit 622 executes the operation simulation sim in which an operation at a time when the target CPU 101 executes the target program pgr is simulated. Details of the process performed by the prediction simulation execution unit 622 will be described later.

Meanwhile, when the second determination unit 614 determines that the second block was a target block in the past and when the first determination unit 612 determines that the second block is a block that performs the process according to an exception, the correspondence information generation unit 615 does not generate correspondence information.

When the first determination unit 612 has determined that the second block is not a block that performs the process according to an exception, the detection unit 613 detects the internal state of the target CPU 101 in the operation simulation sim. More specifically, the detection unit 613 obtains the internal state of the target CPU 101 at an end of execution of a block BB executed immediately before the target block in the operation simulation sim as the internal state of the target CPU 101 at a beginning of execution of the target block. When the target block is the block BB to be executed first, however, the internal state at the beginning of the execution of the target block is an initial state. The initial state may be arbitrarily set. For example, the initial state is a state in which the instruction queue 1204 and the reorder buffer 1209 of the target CPU 101, which will be described later, are empty and no instruction has been input to the execution units of the target CPU 101, which will be described later.

When the first determination unit 612 has determined that the second block is not a block that performs the process according to an exception and the second determination unit 614 has determined that the second block was a target block in the past, the second determination unit 614 determines whether the current internal state matches an internal state in the past. More specifically, the second determination unit 614 determines whether the current internal state detected by the detection unit 613 is the same as the internal state detected when the second block was a target block in the past. More specifically, the second determination unit 614 uses the detected current state as a search key and searches the performance value tables TT for correspondence information including an internal state that matches the search key. For example, when the second determination unit 614 has found correspondence information including an internal state that matches the search key, the second determination unit 614 determines that the current internal state is the same as the internal state detected when the second block was a target block in the past. For example, when the second determination unit 614 has not found correspondence information including an internal state that matches the search key, the second determination unit 614 determines that the current internal state is not the same as the internal state detected when the second block was a target block in the past.

When the first determination unit 612 has determined that the second block is not a block that performs the process according to an exception and the second determination unit 614 has determined that the second block was not a target block in the past, the correspondence information generation unit 615 generates correspondence information. The correspondence information generation unit 615 executes the operation simulation sim of the target block. As a result, the correspondence information generation unit 615 generates correspondence information in which the internal state detected by the detection unit 613 and the performance values of the instructions included in the target block obtained by the operation simulation are associated with each other. More specifically, for example, the prediction simulation execution unit 622 executes, based on the timing information 640 and the prediction information 641, the operation simulation sim in which the target block is executed under certain conditions that assume a certain result of execution.

More specifically, for example, the prediction simulation execution unit 622 sets a predicted result of each externally dependent instruction included in the target block, based on the prediction information 641. The prediction simulation execution unit 622 then executes each instruction on the premise of the set predicted result (predicted case) by referring to the timing information 640 based on the detected internal state of the target CPU 101, to simulate the progress of the execution of each instruction.

Here, a load instruction will be taken as an example. For example, the prediction simulation execution unit 622 simulates, for a process for which a “cache hit” has been set as a predicted result of the load instruction, execution of the process on premises that a result of cache access by the load instruction included in the target block is a “hit”.

In addition, the prediction simulation execution unit 622 outputs, for example, an execution start time and a performance value (execution might not have been completed) for each instruction included in the target block, as results of the simulation. In addition, the prediction simulation execution unit 622 records, for example, the internal state of the target CPU 101 at a time when the simulation of the target block has ended, in the correspondence information. The execution of the target block ends, for example, when all the instructions included in the target block have been stored in the instruction queue 1204 of the target CPU 101, details of which will be described later.

### Operation Simulation Sim

The operation simulation sim, in which an operation when the target CPU 101 has executed the target program pgr is simulated, will be described hereinafter. Here, a processor with out-of-order execution in which two instructions are simultaneously decoded is assumed as a specification of the target CPU 101. In addition, the target CPU 101 includes four-stage pipelines (F-D-E-W).

In an F stage, instructions are obtained from the memory. In a D stage, the instructions are decoded and input to the instruction queue (IQ) 1204, and then recorded in the reorder buffer (ROB) 1209. In an E stage, instructions in the instruction queue 1204 that may be executed are input to the execution units, and after completion of the processes performed by the execution units, the states of the instructions in the reorder buffer 1209 are changed to “completed”. In a W stage, the completed instructions are removed from the reorder buffer 1209.

In addition, the target CPU 101 includes the two ALUs 1205 and 1206, the load/store unit 1207, and the branching unit 1208. The number of cycles to be executed (reference value) of each instruction in each execution unit may be arbitrarily set. For example, the number of cycles to be executed when the ALUs 1205 and 1206 execute a mul instruction is set at 2, the number of cycles to be executed when the branching unit 1208 executes a branch instruction is set at 0, and the number of cycles to be executed when any execution unit executes any other instruction is set at 1.

FIG. 12 is a block diagram illustrating an example of a configuration of a target CPU, according to an embodiment. For example, the target CPU 101 includes a program counter 1201, an instruction cache 1202, a reservation station 1203, the ALUs 1205 and 1206, the load/store unit 1207, the branching unit 1208, and the reorder buffer 1209.

The instruction cache 1202 stores instructions obtained from the memory (not illustrated). The reservation station 1203 includes the instruction queue 1204. The instruction queue 1204 stores decoded instructions in the instruction cache 1202 fetched from a region indicated by an address stored in the PC 1201. The ALUs 1205 and 1206 are execution units that perform arithmetic and logical operations such as a mul instruction and an add instruction. The load/store unit 1207 is an execution unit that executes a load/store instruction. The branching unit 1208 is an execution unit that executes a branch instruction. The reorder buffer 1209 stores decoded instructions. In addition, the reorder buffer 1209 includes, for each instruction stored therein, information indicating either a “waiting” state or a “completed” state.

In addition, the prediction simulation execution unit 622 illustrated in FIG. 6 executes the operation simulation sim by, for example, providing the target program pgr for a model such as the target CPU 101. Here, a predicted case in which all external factors are “hits” is set as a condition of the operation simulation sim. For example, “instruction cache 1202: prediction=hit, data cache: prediction=hit, TLB search: prediction=hit, branch prediction: prediction=hit, call/return stack: prediction=hit” is set.

Information to be input is the target code of the target block and the internal state of the target CPU 101 at the beginning of execution of the target block. In addition, information to be output is, for example, an execution start time and a performance value (execution might not have been completed) of each instruction included in the target block and the internal state of the target CPU 101 at a time when the execution of the target block has been completed.

In addition, in this embodiment, when the target block is a block that performs the process according to an exception, the target CPU 101 performs a pipeline flush when an exception has occurred. Therefore, the information to be input includes the internal state SF of the target CPU 101 at a time when the target CPU 101 has been subjected to the pipeline flush.

### Example of Generation of Correspondence Information According To Internal State

Here, first, an example of generation of correspondence information according to a detected internal state will be described in detail.

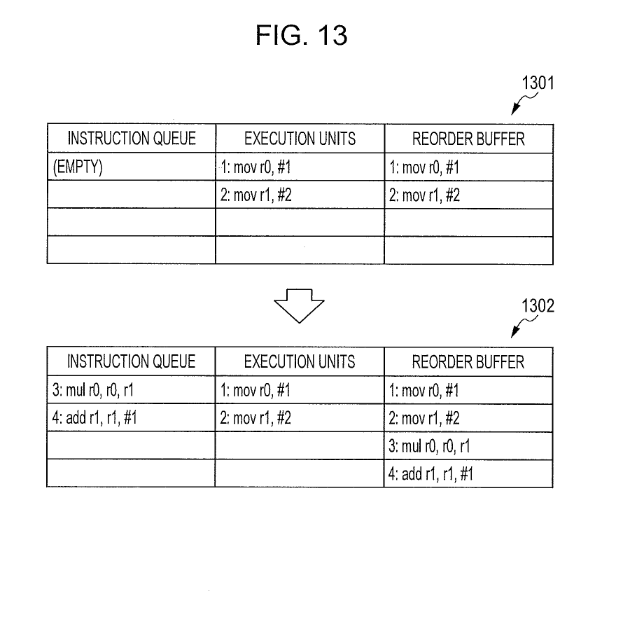

An example of an operation of the target CPU 101 when the target CPU 101 has executed the target code 900 in the operation simulation sim will be described hereinafter with reference to FIGS. 13 to 20.

### Example of Changes in Internal State of Target CPU 101

FIGS. 13 to 20 are diagrams illustrating an example of changes in the internal state of a target CPU, according to an embodiment. In FIG. 13, an internal state 1301 indicates the internal state of the target CPU 101 at the beginning of execution of a target block b2 in the operation simulation sim. Here, as the internal state of the target CPU 101, instructions stored in the instruction queue 1204, instructions input to the execution units (the ALUs 1205 and 1206, the load/store unit 1207, and the branching unit 1208), and instructions stored in the reorder buffer 1209 are illustrated.

In the internal state 1301, the instruction queue 1204 is empty. Instruction 1 (mov rO, #1) and Instruction 2 (mov r1, #2) have been input to the execution units. The reorder buffer 1209 stores Instruction 1 (mov rO, #1) and Instruction 2 (mov r1, #2).

In the operation simulation sim, first, the prediction simulation execution unit 622 illustrated in FIG. 6 executes stage_d(). An internal state 1302 indicates the internal state of the target CPU 101 after the execution of stage_d() (refer to FIG. 13).

In the internal state 1302, the instruction queue 1204 stores Instruction 3 (mul r0, r0, r1) and Instruction 4 (add r1, r1, #1). Instruction 1 (mov r0, #1) and Instruction 2 (mov r1, #2) have been input to the execution units. The reorder buffer 1209 stores Instruction 1 (mov r0, #1), Instruction 2 (mov r1, #2), Instruction 3 (mul r0, r0, r1), and Instruction 4 (add r1, r1, #1).

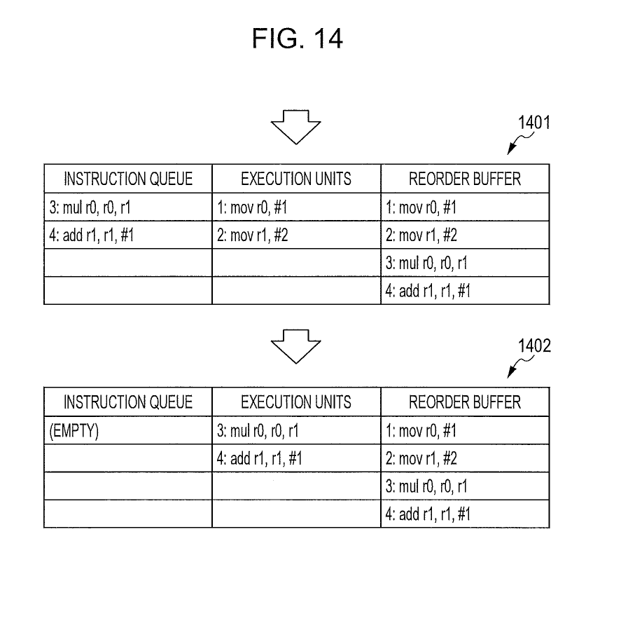

In the operation simulation sim, next, the prediction simulation execution unit 622 executes stage_w(). The internal state 1401 indicates the internal state of the target CPU 101 after the execution of stage_w() (refer to FIG. 14).

In an internal state 1401, the instruction queue 1204 stores Instruction 3 (mul r0, r0, r1), and Instruction 4 (add r1, r1, #1). Instruction 1 (mov r0, #1) and Instruction 2 (mov r1, #2) have been input to the execution units. The reorder buffer 1209 stores Instruction 1 (mov r0, #1), Instruction 2 (mov r1, #2), Instruction 3 (mul r0, r0, r1), and Instruction 4 (add r1, r1, #1).

Here, because no instructions have been completed, the internal state of the target CPU 101 does not change before and after the execution of stage_w().

In the operation simulation sim, next, the prediction simulation execution unit 622 executes stage_e(). As a result, a loop of a main routine has been executed once. An internal state 1402 indicates the internal state of the target CPU 101 after the execution of stage_e() (refer to FIG. 14).

In the internal state 1402, the instruction queue 1204 is empty. Instruction 3 (mul r0, r0, r1) and Instruction 4 (add r1, r1, #1) have been input to the execution units. The reorder buffer 1209 stores Instruction 1 (mov r0, #1), Instruction 2 (mov r1, #2), Instruction 3 (mul r0, r0, r1), and Instruction 4 (add r1, r1, #1).

Here, because the execution units have completed the execution of Instructions 1 and 2, Instructions 1 and 2 are removed from the execution units. Since the execution units became empty, Instructions 3 and 4 are input to the execution units from the instruction queue 1204.

The values of variables (cycle and end) after the loop of the main routine are executed once are as follows:
cycle: 1
end: false

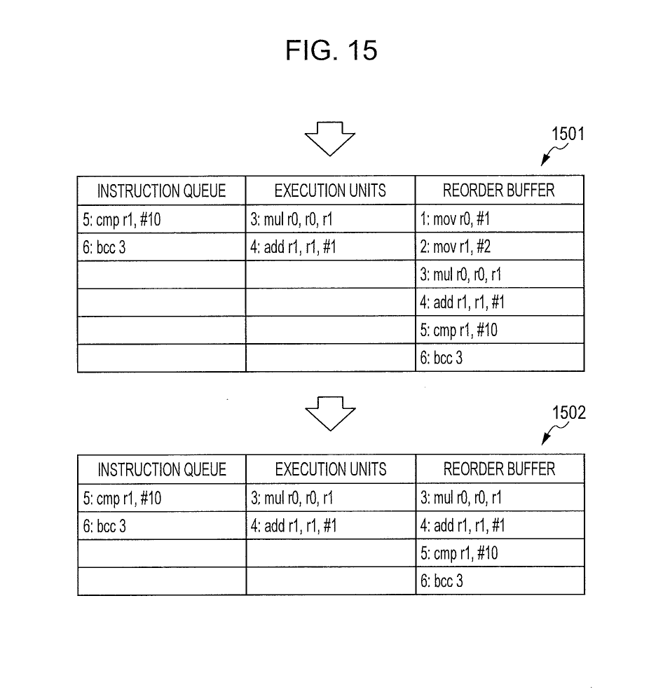

In the operation simulation sim, next, the prediction simulation execution unit 622 executes a second round of stage_d(). An internal state 1501 indicates the internal state of the target CPU 101 after the execution of the second stage_d() (refer to FIG. 15).

In the internal state 1501, the instruction queue 1204 stores Instruction 5 (cmp r1, #10) and Instruction 6 (bcc 3). Instruction 3 (mul r0, r0, r1) and Instruction 4 (add r1, r1, #1) have been input to the execution units. The reorder buffer 1209 stores Instruction 1 (mov r0, #1), Instruction 2 (mov r1, #2), Instruction 3 (mul r0, r0, r1), Instruction 4 (add r1, r1, #1), Instruction 5 (cmp r1, #10), and Instruction 6 (bcc 3).

Here, because Instruction 6 is a last instruction of the target block b2, the value of a variable (end) is “true”.

In the operation simulation sim, next, the prediction simulation execution unit 622 executes a second round of stage_w(). An internal state 1502 indicates the internal state of the target CPU 101 after the execution of the second stage_w() (refer to FIG. 15).

In the internal state 1502, the instruction queue 1204 stores Instruction 5 (cmp r1, #10) and Instruction 6 (bcc 3). Instruction 3 (mul r0, r0, r1) and Instruction 4 (add r1, r1, #1) have been input to the execution units. The reorder buffer 1209 stores Instruction 3 (mul r0, r0, r1), Instruction 4 (add r1, r1, #1), Instruction 5 (cmp r1, #10), and Instruction 6 (bcc 3).

Here, because Instructions 1 and 2 have been completed, Instructions 1 and 2 are removed from the reorder buffer 1209.

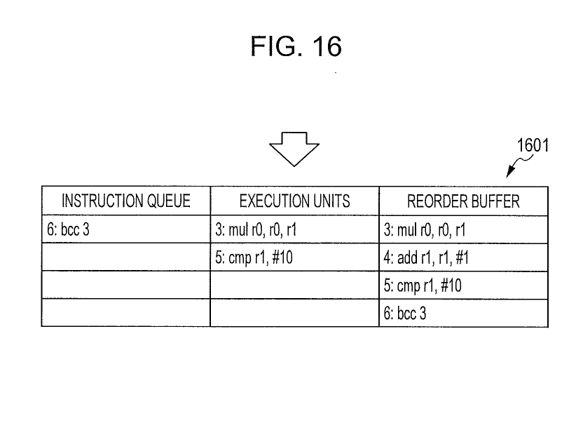

In the operation simulation sim, next, the prediction simulation execution unit 622 executes a second round of stage_e(). As a result, the loop of the main routine has been executed twice. An internal state 1601 indicates the internal state of the target CPU 101 after the execution of the second stage_e() (refer to FIG. 16).

In the internal state 1601, the instruction queue 1204 stores Instruction 6 (bcc 3). Instruction 3 (mul r0, r0, r1) and Instruction 5 (cmp r1, #10) have been input to the execution units. The reorder buffer 1209 stores Instruction 3 (mul r0, r0, r1), Instruction 4 (add r1, r1, #1), Instruction 5 (cmp r1, #10), and Instruction 6 (bcc 3).

Here, because the execution units have completed the execution of Instruction 4, Instruction 4 is removed from the execution units. Since Instruction 3 is a mul instruction and takes two cycles, the execution of Instruction 3 has not been completed. Since the execution units, namely the ALUs 1205 and 1206, have a vacancy, Instruction 5 has been input to the execution units from the instruction queue 1204. Because Instruction 6 depends on Instruction 5 and accordingly is not executable, Instruction 6 is not executed and remains in the instruction queue 1204.

The values of the variables (cycle and end) after the loop of the main routine are executed twice are as follows:
cycle: 2
end: true

Here, since the value of the variable (end) is “true”, the prediction simulation execution unit 622 returns results of the simulation indicating the execution start times and the performance values of the instructions executed in the target block b2. As a result, the execution of the target block b2 in the operation simulation sim ends. In this case, the prediction simulation execution unit 622 may return the number of cycles executed “2” which indicates the performance value of the target block b2.

Since the last instruction, namely Instruction 6, of the target block b2 has been stored in the instruction queue 1204, the target block in the operation simulation sim switches. Here, it is assumed that a result of a branch prediction realized by the branch instruction in the sixth row of the target code 900 is a “hit” (predicted case), and the block b2, which corresponds to the third to sixth rows, is again determined as the target block by returning to the third row which is the resultant branch.

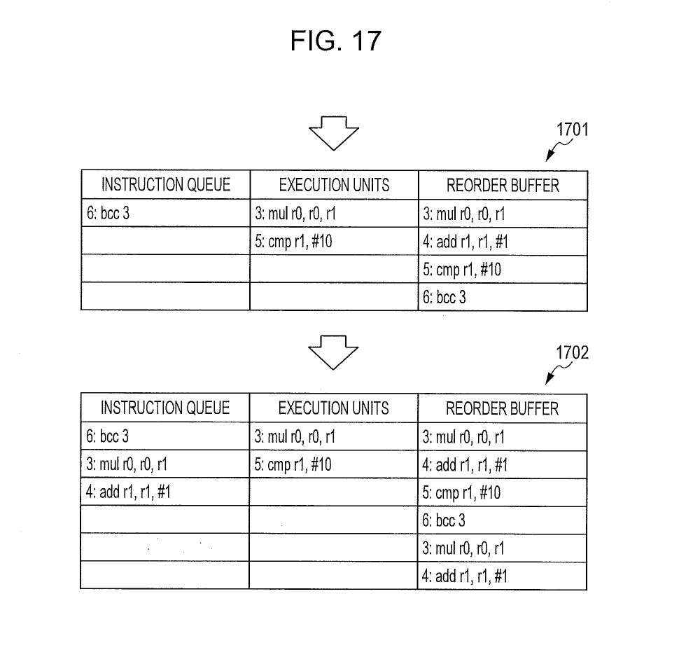

In FIG. 17, an internal state 1701 indicates the internal state of the target CPU 101 at the beginning of the execution of a second round of the target block b2 in the operation simulation sim. The internal state 1701 is the same as the internal state 1601 at the end of the execution of the first round of the target block b2.

In the operation simulation sim, first, the prediction simulation execution unit 622 executes stage_d(). An internal state 1702 indicates the internal state of the target CPU 101 after the execution of stage_d() (refer to FIG. 17).

In the internal state 1702, the instruction queue 1204 stores Instruction 6, Instruction 3, and Instruction 4. Instruction 3 and Instruction 5 have been input to the execution units. The reorder buffer 1209 stores Instruction 3, Instruction 4, Instruction 5, Instruction 6, Instruction 3, and Instruction 4.

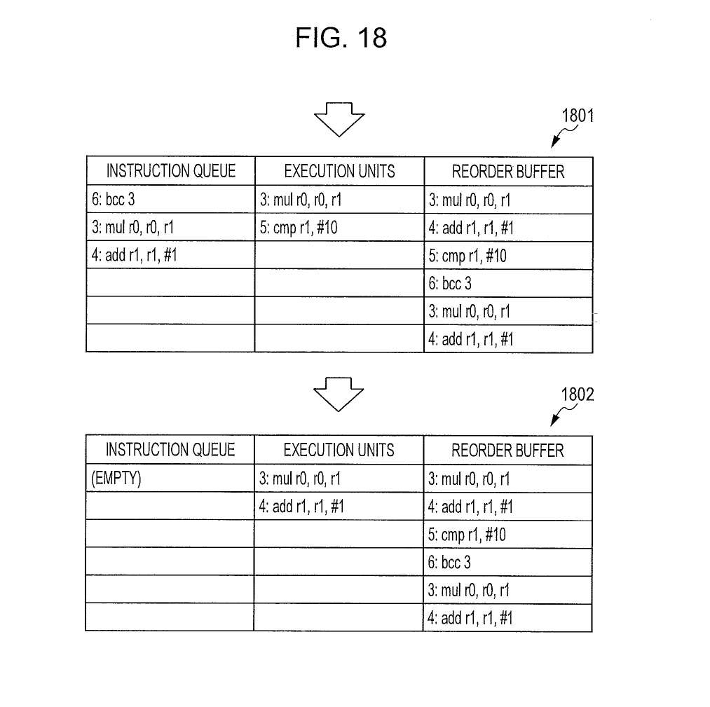

In the operation simulation sim, next, the prediction simulation execution unit 622 executes stage_w(). An internal state 1801 indicates the internal state of the target CPU 101 after the execution of stage_w() (refer to FIG. 18).

In the internal state 1801, the instruction queue 1204 stores Instruction 6, Instruction 3, and Instruction 4. Instruction 3 and Instruction 5 have been input to the execution units. The reorder buffer 1209 stores Instruction 3, Instruction 4, Instruction 5, Instruction 6, Instruction 3, and Instruction 4.

Here, because Instruction 4 has been completed but Instruction 3 is being executed, the internal state of the target CPU 101 does not change before and after the execution of stage_w().

In the operation simulation sim, next, the prediction simulation execution unit 622 executes stage_e(). As a result, the loop of the main routine has been executed once. An internal state 1802 indicates the internal state of the target CPU 101 after the execution of stage_e() (refer to FIG. 18).

In the internal state 1802, the instruction queue 1204 is empty. Instruction 3 and Instruction 4 have been input to the execution units. The reorder buffer 1209 stores Instruction 3, Instruction 4, Instruction 5, Instruction 6, Instruction 3, and Instruction 4.

Here, because the execution units have completed the execution of Instructions 3 and 5, Instructions 3 and 5 are removed from the execution units. In addition, the execution unit became empty, and Instructions 3 and 4 has been input to the execution units from the instruction queue 1204. Because Instruction 6 is a branch instruction and accordingly the number of cycles to be executed is 0, Instruction 6 is completed without being input to the execution units.

The values of the variables (cycle and end) after the loop of the main routine are executed once are as follows:
cycle: 1
end: false

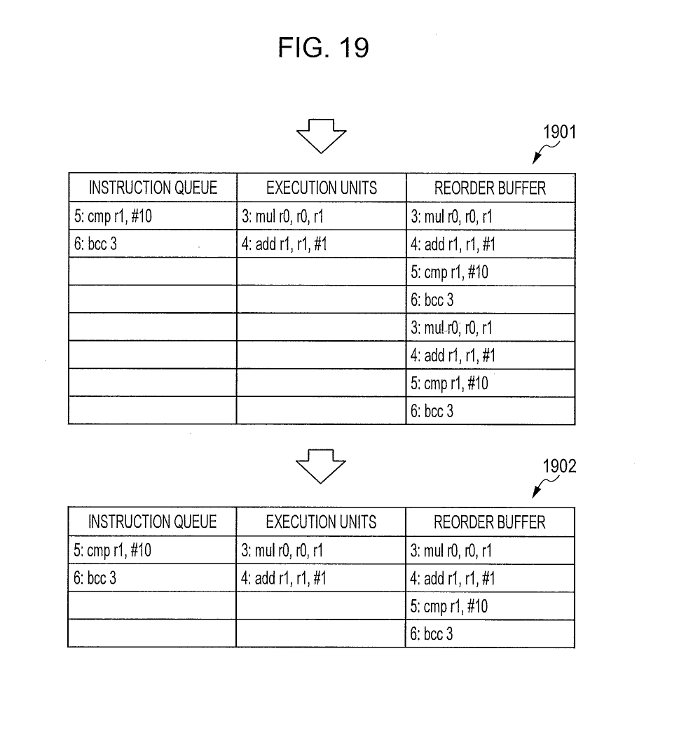

In the operation simulation sim, next, the prediction simulation execution unit 622 executes a second round of stage_d(). An internal state 1901 indicates the internal state of the target CPU 101 after the execution of the second round of stage_d() (refer to FIG. 19).

In the internal state 1901, the instruction queue 1204 stores Instruction 5 and Instruction 6. Instruction 3 and Instruction 4 have been input to the execution units. The reorder buffer 1209 stores Instruction 3, Instruction 4, Instruction 5, Instruction 6, Instruction 3, Instruction 4, Instruction 5, and Instruction 6.

Here, since Instruction 6 is the last instruction in the target block b2, the value of the variable (end) becomes “true”.

In the operation simulation sim, next, the prediction simulation execution unit 622 executes a second round of stage_w(). An internal state 1902 indicates the internal state of the target CPU 101 after the execution of the second round of stage_w() (refer to FIG. 19).

In the internal state 1902, the instruction queue 1204 stores Instruction 5 and Instruction 6. Instruction 3 and Instruction 4 have been input to the execution units. The reorder buffer 1209 stores Instruction 3, Instruction 4, Instruction 5, and Instruction 6.

Here, because Instructions 3, 4, 5, and 6 have been completed, Instructions 3, 4, 5, and 6 are removed from the reorder buffer 1209.

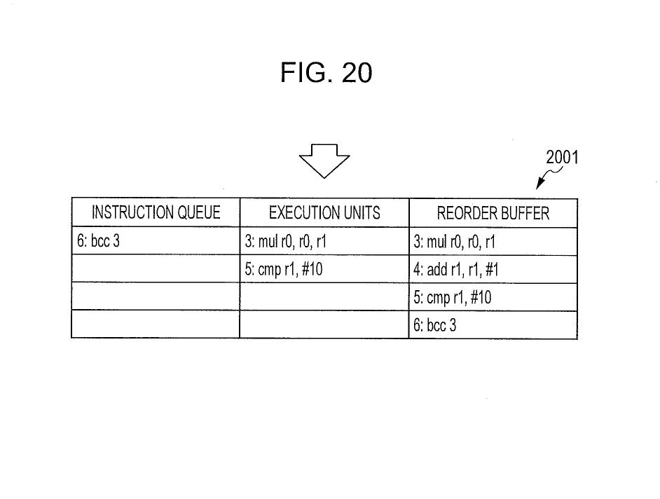

In the operation simulation sim, next, the prediction simulation execution unit 622 executes a second round of stage_e(). As a result, the loop of the main routine has been executed twice. An internal state 2001 indicates the internal state of the target CPU 101 after the execution of the second round of stage_e() (refer to FIG. 20).

In the internal state 2001, the instruction queue 1204 stores Instruction 6. Instruction 3 and Instruction 5 have been input to the execution units. The reorder buffer 1209 stores Instruction 3, Instruction 4, Instruction 5, and Instruction 6.

Here, because the execution units have completed the execution of Instruction 4, Instruction 4 is removed from the execution units. Since Instruction 3 is a mul instruction and takes two cycles, the execution of Instruction 3 has not been completed. Since the execution units, namely the ALUs 1205 and 1206, are available, the instruction queue 1204 has input Instruction 5 to the execution units. Because Instruction 6 depends on Instruction 5 and accordingly is not executable, Instruction 6 is not executed and remains in the instruction queue 1204.

The values of the variables (cycle and end) after the loop of the main routine are executed twice are as follows:
cycle: 2
end: true

Here, since the value of the variable (end) is “true”, the prediction simulation execution unit 622 returns results of the simulation indicating the execution start times and the performance values of the instructions executed in the second target block b2. As a result, the execution of the target block b2 in the operation simulation sim ends.

### Specific Example of Performance Value Table TT

Next, a specific example of the performance value table TT when the target block does not include an externally dependent instruction will be described. For example, the execution start times and the performance values of the instructions included in the target block b2 which are output as the results of the above-described operation simulation sim of the target block b2 are as follows:
Execution Start Times of Instructions
   Instruction 3: 0
   Instruction 4: 0
   Instruction 5: 1
   Instruction 6: 2
Performance Values of Instructions
   Instruction 3: 0
   Instruction 4: 1
   Instruction 5: 1

When the target block has changed from the first block to the second block, the association unit 616 illustrated in FIG. 6 associates generated correspondence information 2101 regarding the second block with generated correspondence information 2101 regarding the first block. More specifically, the association unit 616 associates a pointer of the second block and a pointer of the correspondence information 2101 regarding the second block generated by the correspondence information generation unit 615 with the correspondence information 2101 regarding the first block.

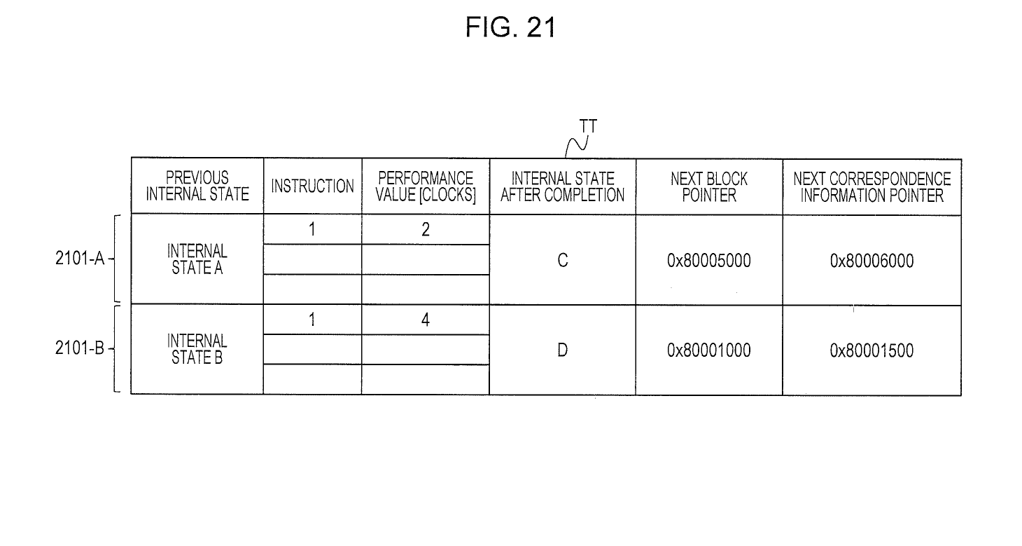

FIG. 21 is a diagram illustrating an example of a performance value table, according to an embodiment. The performance value table TT includes fields of previous internal state, instruction, performance value, internal state after completion, next block pointer, and next correspondence information pointer. By setting information in each field, correspondence information 2101 is stored as a record. The performance value table TT is realized by a storage device such as the disk 505.

In the previous internal state field, a detected internal state is set unless the target block is a block that performs the process according to an exception. When the target block is a block that performs the process according to an exception, the internal state SF is set in the previous internal state field. In the instruction field, instructions included in the target block are set. As illustrated in FIG. 21, however, nothing may be set in the instruction field when the performance values of the instructions included in the target block are collectively expressed. In the performance value field, the performance values, which are the results of the operation simulation sim, of the instructions are set.

In the next block pointer field, the pointer of a block that was a target block in the past is set. In the next correspondence information pointer field, the pointer of the correspondence information 2101 used when the block was a target block in the past is set. For example, the correspondence information generation unit 615 illustrated in FIG. 6 sets “null” in the next block pointer field and the next correspondence information pointer field for the generated correspondence information 2101.

In correspondence information 2101-A, in which the previous internal state is Internal State A, the performance value of each instruction in Internal State A is 2. Here, the performance value is the number of cycles. For example, Internal State A is the above-described internal state 1301. In the correspondence information 2101-A, the internal state after the completion is Internal State C. For example, Internal State C is the above-described internal state 2001.

Correspondence information 2101-B, in which the previous internal state is Internal State B, is an example different from the examples illustrated in FIGS. 13 to 20 and the example of the correspondence information 2101-A. In the correspondence information 2101-B, in which the previous internal state is Internal State B, the performance value of each instruction in Internal State B is four clocks. Although a value collectively expressing the performance values of the instructions is indicated in FIG. 21, the performance values of the instructions may be individually expressed. When the target block includes an externally dependent instruction or the like, a helper function call instruction or the like is included in the host codes hc, and accordingly the performance values of the instructions may be individually set in the correspondence information.

In the correspondence information 2101-A, “0x80005000” is set in the next block pointer field, and “0x80006000” is set in the next correspondence information pointer field. In the correspondence information 2101-B, “0x80001000” is set in the next block pointer field, and “0x80001500” is set in the next correspondence information pointer field.

For example, in the next correspondence information pointer field, an offset to the next correspondence information 2101 may be set. For example, the offset is a difference between the pointer of the next block and the pointer of the next correspondence information 2101. For example, in the case of the correspondence information 2101-A, “0x80005000” is set in the next block pointer field, and “0x1000” is set in the next correspondence information pointer field. As a result, it is determined that the pointer of the next correspondence information 2101 is “0x80006000”. For example, in the case of the correspondence information 2101-B, “0x80001000” is set in the next block pointer field, and “0x500” is set in the next correspondence information pointer field. As a result, it is determined that the next correspondence information pointer is “0x80001500”. Thus, by setting the offset to the next correspondence information 2101, the amount of information of the correspondence information 2101 may be reduced, thereby reducing the amount of memory used.

In addition, when the target block has changed from the first block to the second block, the second determination unit 614 illustrated in FIG. 6 determines whether the target block changed from the first block to the second block in the past. More specifically, the second determination unit 614 determines whether the pointer of the next block included in the correspondence information 2101 regarding the first block matches the pointer of the second block. When the second determination unit 614 determines that the pointer of the next block included in the correspondence information 2101 regarding the first block does not match the pointer of the second block, the second determination unit 614 determines that the target block did not change from the first block to the second block in the past, and determines whether the second block was a target block in the past. The process performed after the determination whether the second block was a target block in the past is as described above.

On the other hand, when the second determination unit 614 determines that the pointer of the next block included in the correspondence information 2101 regarding the first block matches the pointer of the second block, the second determination unit 614 determines that the target block changed from the first block to the second block in the past. The second determination unit 614 then determines whether the internal state associated in the correspondence information 2101 regarding the first block when the second block was a target block in the past matches the internal state detected for the second block. That is, the second determination unit 614 determines whether the internal state associated in the correspondence information 2101 indicated by the pointer of the next correspondence information included in the correspondence information 2101 regarding the first block matches the internal state detected by the detection unit 613 for the second block.

When the second determination unit 614 determines that the internal state associated in the correspondence information 2101 regarding the first block when the second block was a target block in the past does not match the internal state detected for the second block, the second determination unit 614 determines whether the second block was a target block in the past. The process performed after the determination whether the second block was a target block in the past is as described above, and accordingly detailed description thereof is omitted.

On the other hand, when the second determination unit 614 determines that the internal state associated in the correspondence information 2101 regarding the first block when the second block was a target block in the past matches the internal state detected for the second block, the simulation execution unit 602 executes the host codes hc in the second block using the correspondence information 2101 associated with the correspondence information 2101 generated for the first block.

Thus, by associating pieces of correspondence information 2101 that are likely to be used with each other, the speed of processing for searching for the correspondence information 2101 in which the internal state detected from the performance value table TT is associated increases.

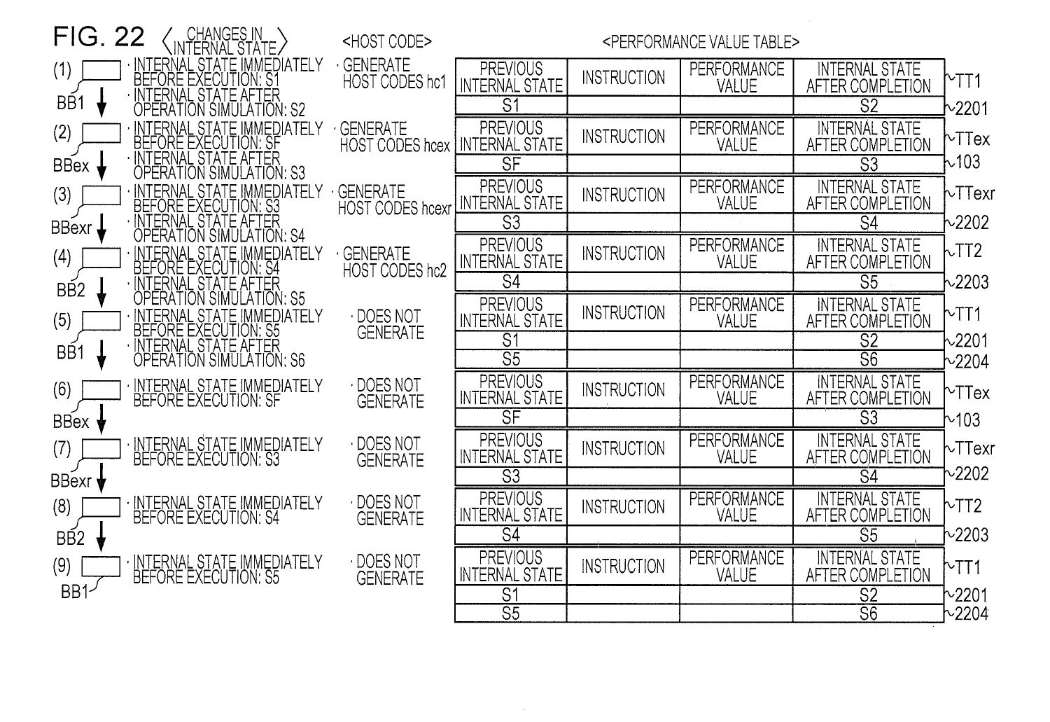

FIG. 22 is a diagram illustrating an example of a relationship between generation of host codes and correspondence information, according to an embodiment. Here, an example in which the target block repeatedly switches in the cyclical order of the block BB1, the block BBex, the block BBexr, the block BB2, and the block BB1 will be described to facilitate understanding. In FIG. 22, each performance value table TT and correspondence information included in each performance value table TT are simplified.

First, (1) when the target block is the block BB1, the internal state of the target CPU 101 in the operation simulation sim immediately before execution of the block BB1 is S1. The code generation unit 617 generates the host codes hc1 corresponding to the block BB1. The generated host codes hc 1 are stored in the above-described host code list 102. The correspondence information generation unit 615 generates correspondence information 2201 based on the internal state S1 by executing the operation simulation sim. The generated correspondence information 2201 is stored in the performance value table TT1. The internal state of the processor after the operation simulation sim is S2.

Next, (2) when the target block is the block BBex, the correspondence information generation unit 615 changes the internal state of the processor in the operation simulation sim to the internal state SF, since the block BBex is a block that performs the exception process. The code generation unit 617 generates the host codes hcex corresponding to the block BBex. The generated host codes hcex are stored in the above-described host code list 102. The correspondence information generation unit 615 generates the correspondence information 103 based on the internal state SF by executing the operation simulation sim. The generated correspondence information 103 is stored in the performance value table TTex. The internal state of the processor after the operation simulation sim is S3.

Next, (3) when the target block is the block BBexr, the internal state of the target CPU 101 in the operation simulation sim immediately before execution of the block BBexr is S3. The code generation unit 617 generates host codes hcexr corresponding to the block BBexr. The generated host codes hcexr are stored in the above-described host code list 102. The correspondence information generation unit 615 generates correspondence information 2202 based on the internal state S3 by executing the operation simulation sim. The generated correspondence information 2202 is stored in the performance value table TTexr. The internal state of the target CPU 101 after the operation simulation sim is S4.

Next, (4) when the target block is the block BB2, the internal state of the target CPU 101 in the operation simulation sim immediately before execution of the block BB2 is S4. The code generation unit 617 generates host codes hc2 corresponding to the block BB2. The generated host codes hc2 are stored in the above-described host code list 102. The correspondence information generation unit 615 generates correspondence information 2203 based on the internal state S4 by executing the operation simulation sim. The generated correspondence information 2203 is stored in a performance value table TT2. The internal state of the target CPU 101 after the operation simulation sim is S5.

Next, (5) when the target block is the block BB1, the internal state of the target CPU 101 in the operation simulation sim immediately before execution of the block BB1 is S5. Since the host codes hc1, which correspond to the block BB1, have already been generated, the code generation unit 617 does not newly generate the host codes hc1. Since the internal state registered to the performance value table TT and the current internal state are different, the correspondence information generation unit 615 generates correspondence information 2204 based on the internal state S5 by executing the operation simulation sim. The generated correspondence information 2204 is stored in the performance value table TT1. The internal state of the target CPU 101 after the operation simulation sim is S6.

Next, (6) when the target block is the block BBex, the code generation unit 617 does not newly generate the host code hcex, since the block BBex already became the target block. Since the block BBex is a block that performs the exception process, the correspondence information generation unit 615 does not newly generate the correspondence information 103.

Next, (7) when the target block is BBexr, the code generation unit 617 does not newly generate the host codes hcexr, since the block BBexr already became the target block. Since the previous internal state S3 registered to the correspondence information 2202 included in the performance value table TTexr and the current internal state S3 match, the correspondence information generation unit 615 does not newly generate the correspondence information 2202. Here, the current internal state S3 is the internal state S3 after the completion set in the correspondence information 103 used for executing the host codes hcex corresponding to the previous block BBex.

Next, (8) when the target block is the block BB2, the code generation unit 617 does not newly generate the host codes hc2, since the block BB2 already became the target block. Since the previous internal state S4 registered to the correspondence information 2203 included in the performance value table TT2 and the current internal state S4 match, the correspondence information generation unit 615 does not newly generate the correspondence information 2203. Here, the current internal state S4 is the internal state S4 after the completion set in the correspondence information 2202 used for executing the host code hcexr corresponding to the previous block BBexr.

Next, (9) when the target block is the block BB1, the code generation unit 617 does not newly generate the host codes hc1, since the block BB1 already became the target block. Since the previous internal state S5 registered to the correspondence information 2204 included in the performance value table TT1 and the current internal state S5 match, the correspondence information generation unit 615 does not newly generate the correspondence information. Here, the current internal state S5 is the internal state S5 after the completion set in the correspondence information 2203 used for executing the host codes hc2 corresponding to the previous block BB2.

As described above, it is sufficient that the host codes hc and the correspondence information be generated only once for the block BBex which performs the exception process. Therefore, the amount of memory used is reduced. In addition, the previous block of the block BBexr, which performs the exception routine, is the block BBex, and the host CPU is subjected to a pipeline flush before the execution start time of the block BBex. Therefore, it is sufficient that the host codes hc and the correspondence information be generated only once. Therefore, the amount of memory used is reduced.

The simulation execution unit 602 calculates the performance values at a time when the target CPU 101 has executed the target block by executing, based on the internal state and the correspondence information, the host codes hc generated by the code generation unit 617. That is, the simulation execution unit 602 performs a simulation of the functions and the performance in execution of the instructions by the target CPU 101 that executes the target program pgr.

More specifically, the simulation execution unit 602 includes the code execution unit 631 and a correction unit 632. The code execution unit 631 executes host codes hc of a target block. More specifically, for example, the code execution unit 631 obtains the host codes hc corresponding to the block ID of the target block from the host code list 102 and executes the obtained host codes hc based on the current internal state.

When the host codes hc of the target block have been executed, the simulation execution unit 602 may identify a block BB to be processed next. Therefore, the simulation execution unit 602 changes the value of the PC 1201 in the operation simulation sim in such a way as to indicate an address at which the block BB is stored. Alternatively, for example, the simulation execution unit 602 outputs information (for example, the block ID) regarding the block BB to be processed next to the code conversion unit 601. As a result, the code conversion unit 601 may recognize the switching of the target block in the performance simulation after the execution of the host codes hc and the next target block in the operation simulation sim.

When a helper function call instruction has been executed during the performance simulation, the code execution unit 631 calls the correction unit 632, which is a helper function. When a result of execution of an externally dependent instruction is different from a predicted result set in advance (unpredicted case), the correction unit 632 obtains the performance value of the instruction by correcting the already obtained performance value in the predicted case. More specifically, for example, the correction unit 632 determines whether the result of the execution of the externally dependent instruction is different from the predicted result set in advance by executing the operation simulation in which the operation when the target CPU 101 has executed the target program pgr is simulated. The operation simulation by the correction unit 632 is executed, for example, by supplying the target program pgr to a system model including the target CPU 101 and a hardware resource, such as a cache, that may be accessed by the target CPU 101. For example, when the externally dependent instruction is an Id instruction, the hardware resource is a cache memory.

The correction unit 632 then performs correction using penalty time provided for the externally dependent instruction, performance values of instructions executed before and after the externally dependent instruction, delay time of the previous instruction, or the like. Here, the performance value of the externally dependent instruction in the predicted case is already expressed as a constant. Therefore, the correction unit 632 may calculate the performance value of the externally dependent instruction in the unpredicted case by simply adding or subtracting the value of the penalty time of the instruction, the performance values of the instructions executed before and after the instruction, the delay time of the previously processed instruction, or the like.

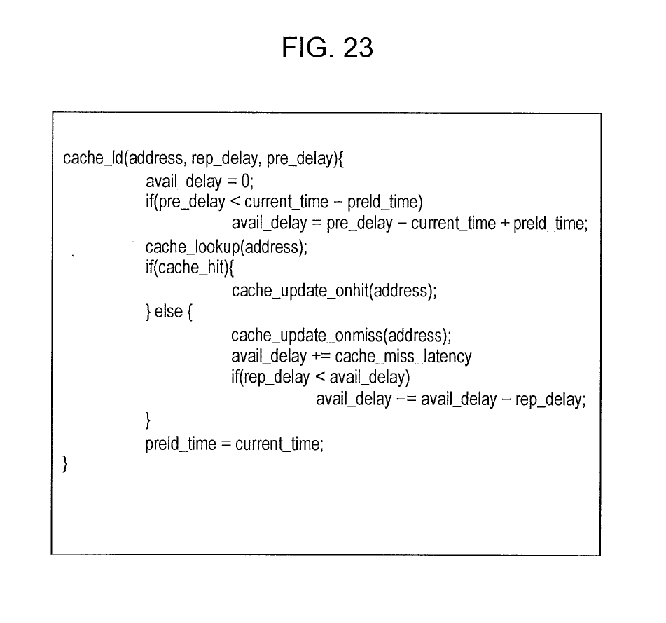

FIG. 23 is a diagram illustrating an example of a processing operation performed by a correction unit, according to an embodiment. The correction unit 632 is used as a helper function module. In this embodiment, for example, the processing operation is realized, for example, by incorporating a helper function call instruction “cache_Id(address, rep_delay, pre_delay)” into the host codes hc instead of a function “cache_Id(address)” which performs a simulation for each result of execution of a cache of the Id instruction.

In the helper function, “rep_delay” indicates time (suspension time) in penalty time that is not processed as delay time until execution of a next instruction that uses a return value of this load (Id) instruction. “pre_delay” indicates delay time received from a previous instruction. “−1” indicates that no delay is caused by the previous instruction. “rep_delay” and “pre_delay” are time information obtained from results of a process for statically analyzing the results of the performance simulation and the timing information 640.

In the operation example illustrated in FIG. 23, when a difference between a current timing current_time and an execution timing preld_time of a previous Id instruction exceeds delay time pre_delay of the previous Id instruction, the correction unit 632 illustrated in FIG. 6 obtains available delay time avail_delay by adjusting the delay time pre_delay using time from the execution time preld_time of the previous Id instruction to the current timing current time.

When a result of the execution is a cache miss, the predicted result is wrong. The correction unit 632 adds penalty time cache_miss_latency for a cache miss to the available delay time avail_delay and corrects the performance value of the Id instruction based on the suspension time rep_delay.

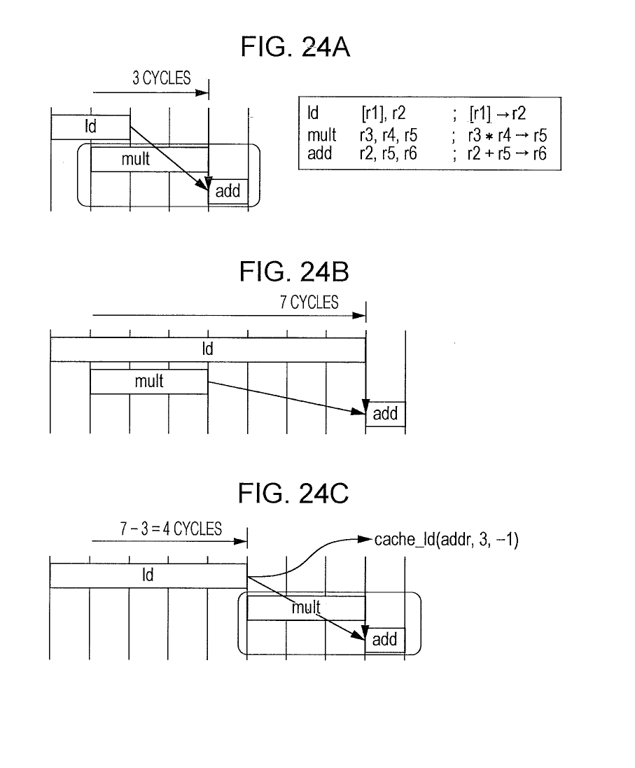

An example of correction of a result of execution of an Id instruction by the correction unit 632 will be described hereinafter with reference to FIGS. 24A to 26C.

FIGS. 24A to 24C are first diagrams illustrating an example of correction performed on a result of execution of an Id instruction, according to an embodiment. In FIGS. 24A to 24C, an example of correction when a cache miss has occurred in a case in which a cache process is executed will be described.

In the example illustrated in FIGS. 24A to 24C, a simulation of the following three instructions is executed:
Id [r1], r2; [r1]→r2
mult r3, r4, r5; r3*r4→r5
add r2, r5, r6; r2+r5→r6

FIG. 24A illustrates an example of a chart of instruction execution timings at a time when a predicted result is a “cache hit”. In this predicted case, a two-cycle stall occurs in an add instruction, which is executed third. FIG. 24B illustrates an example of a chart of instruction execution timings at a time when a “cache miss” occurs despite the predicted result. In this unpredicted case, since the result of the execution of the Id instruction is a cache miss, a delay of penalty cycles (six cycles) is caused. Therefore, although a mult instruction is executed without being affected by the delay, the execution of the add instruction delays by four cycles in order to wait for completion of the Id instruction. FIG. 24C illustrates an example of a chart of instruction execution timings after the correction performed by the correction unit 632 illustrated in FIG. 6.

Since the result of the execution of the Id instruction is a cache miss (unpredicted result), the correction unit 632 adds the certain penalty time (six cycles) for a cache miss to the remaining performance value (2−1=1 cycle) to obtain the available delay time (seven cycles). The available delay time is maximum delay time. Furthermore, the correction unit 632 obtains the performance value (three cycles) of the next instruction, which is the mult instruction, and determines that the performance value of the next instruction does not exceed the delay time. The correction unit 632 then determines time (7−3=4 cycles) obtained by subtracting the performance value of the next instruction from the available delay time as the performance value (delay time) for which the delay of the Id instruction occurs. In addition, the correction unit 632 determines time (three cycles) obtained by subtracting the delay time from the available delay time as suspension time. The suspension time is time for which delay as a penalty is suspended. The correction unit 632 returns the suspension time rep_delay=3 and the delay time pre_delay=−1 (no delay) of the previous instruction using the helper function cache_Id (address, rep_delay, pre_delay).

As a result of the correction, the performance value of the Id instruction becomes the performance value (1+4=5 cycles) obtained by summing the executed time and the delay time, and the performance values of the subsequent mult instruction and add instruction are calculated from a timing t₁ at which the execution is completed. That is, the performance value (the number of cycles) of the block may be obtained by simply adding, to the corrected performance value (five cycles) of the Id instruction, the performance values (three cycles and three cycles) of the mult instruction and the add instruction obtained as results (results of a prediction simulation using a predicted result) of the process performed by the prediction simulation execution unit 622.

Therefore, the number of cycles executed in a simulation in the case of a cache miss may be accurately calculated by performing the process for correcting only the performance value of an instruction whose result of execution is different from a predicted one through addition or subtraction and, for other instructions, by simply adding the performance values obtained in the simulation based on the predicted result.

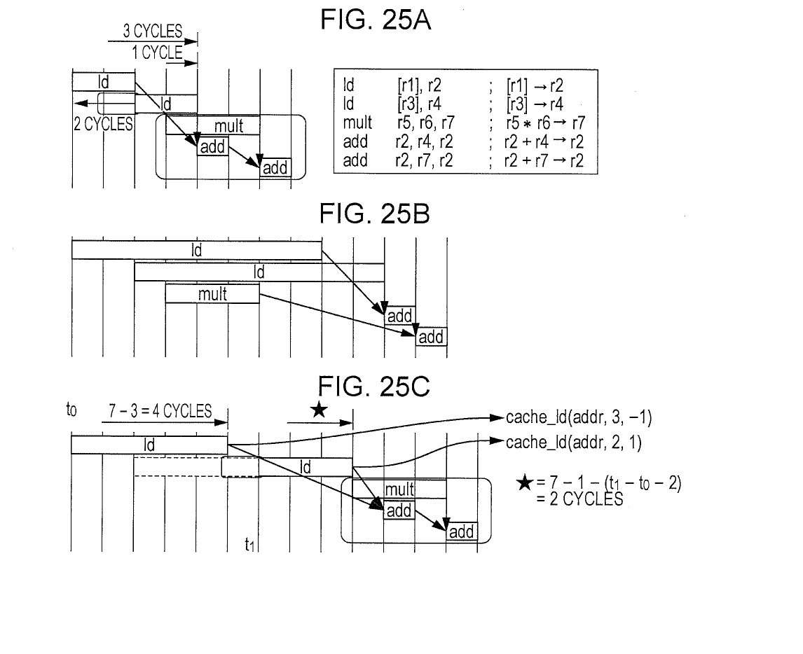

FIGS. 25A to 25C are second diagrams illustrating an example of correction performed on results of execution of Id instructions, according to an embodiment. In FIGS. 25A to 25C, an example of correction when two cache misses have occurred in a case in which two cache processes are executed will be described. In the example illustrated in FIGS. 25A to 25C, a simulation of the following five instructions is executed:
Id [r1], r2; [r1]→r2
Id [r3], r4; [r3]→r4
mult r5, r6, r7; r5*r6→r7
add r2, r4, r2; r2+r4→r2
add r2, r7, r2; r2*r7→r2

FIG. 25A illustrates an example of a chart of instruction execution timings at a time when predicted results of the two cache processes are “cache hits”. In this predicted case, two Id instructions are executed at an interval of two cycles (ordinary one cycle+added one cycle). FIG. 25B illustrates an example of a chart of instruction execution timings at a time when the results of the two cache processes are “cache misses”, which are unpredicted results. In this unpredicted case, cache misses are caused by the two Id instructions, and delays of penalty cycles (six cycles) are caused. Delay times of the two Id instructions, however, overlap and a mult instruction is executed without being affected by the delays, thereby delaying execution of two add instructions until completion of the second Id instruction. FIG. 25C illustrates an example of a chart of instruction execution timings after the correction performed by the correction unit 632 illustrated in FIG. 6.

As described with reference to FIGS. 24A to 24C, the correction unit 632 corrects the delay time of the first Id instruction at a timing t₀ and returns a helper function cache_Id(addr, 3, −1). Next, since the result of the execution of the second Id instruction is a cache miss (unpredicted result), the correction unit 632 adds, at a current timing t₁, the penalty cycles (six cycles) to the remaining performance value of the Id instruction to obtain the available delay time (1+6=7 cycles).

The correction unit 632 obtains the available delay time that has exceeded the current timing t₁ by subtracting the delay time (<current timing t₁−execution timing t₀ of previous instruction>−set interval) that has elapsed until the current timing t₁ from the available delay timing and determines the available delay time that has exceeded the current timing t₁ as the performance value of the second Id instruction. Furthermore, the correction unit 632 subtracts the original performance value from the available delay time that has exceeded the current timing t₁ (3−1=2 cycles) and determines the result as the delay time of the previous instruction. In addition, the correction unit 632 subtracts the sum of the delay time that has elapsed until the current timing t₁ and the available delay time that has exceeded the current timing t₁ from the available delay time (7−(3+3)=1 cycle) and determines the result as the suspension time.

At the timing t₁, the correction unit 632 corrects the delay time of the second Id instruction, and then returns a helper function cache_Id(addr, 2, 1). As a result of this correction, the timing of the completion of the execution of the Id instruction becomes a timing obtained by adding a correction value (three cycles) to the current timing t₁. From this timing, the performance values of the mult instruction and the add instruction are added.

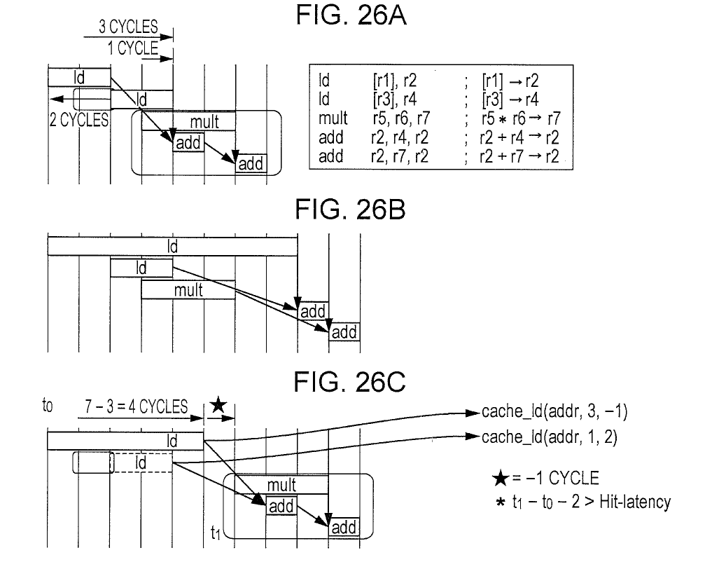

FIGS. 26A to 26C are third diagrams illustrating an example of correction performed on results of execution of Id instructions, according to an embodiment. In FIGS. 26A to 26C, an example of correction when a cache miss has occurred in a case in which two cache processes are executed will be described. In the example illustrated in FIGS. 26A to 26C, a simulation of the same five instructions as in the examples illustrated in FIGS. 25A to 25C are executed.

FIG. 26A illustrates an example of a chart of instruction execution timings at a time when predicted results of the two cache processes are “cache hits”. In this predicted case, as in FIG. 25A, the two Id instructions are executed at an interval of two cycles (ordinary one cycle+added one cycle). FIG. 26B illustrates an example of a chart of instruction execution timings at a time when a “cache miss”, which is an unpredicted result, is caused by the first Id instruction and a predicted result (cache hit) is caused by the second Id instruction. In this unpredicted case, a delay of penalty cycles (six cycles) is caused in each of the two Id instructions. The delay times of the two Id instructions, however, overlap, and the mult instruction is executed without being affected by the delays, thereby delaying the execution of the two add instructions until the completion of the second Id instruction. FIG. 26C illustrates an example of a chart of instruction execution timings after the correction performed by the correction unit 632.

As described with reference to FIG. 24C, at a timing t₀, the correction unit 632 corrects the delay time of the first Id instruction and returns a helper cache_Id(addr, 3, −1). Next, since the result of the execution of the second Id instruction is a cache hit (predicted result), the correction unit 632 determines at a current timing t₁ whether time <t₁−t₀−set interval (6−0−2=4 cycles)>from the beginning of the execution of the Id instruction to the current timing t₁ is longer than the performance value (two cycles) of the Id instruction. Since the time from the beginning of the execution of the second Id instruction to the current timing t₁ is longer than the performance value (two cycles) of the Id instruction, the correction unit 632 determines the current timing t₁ as the execution timing of the next instruction, which is the mult instruction.

The correction unit 632 then determines time (two cycles) from the end of the execution of the second Id instruction to the current timing t₁ as the delay time of the next instruction and sets the delay time pre_delay of the previous instruction to 2. In addition, the correction unit 632 subtracts the sum of delay time that has elapsed until the current timing t₁ and the available delay time that has exceeded the current timing t₁ from the available delay time of the first Id instruction (7−(6+0)=1 cycle) and sets the suspension time rep_delay to 1. The correction unit 632 then returns a helper function cache_Id(addr, 1, 2).

The simulation information collection unit 603 collects log information (simulation information) including the performance values of the blocks BB as results of execution of performance simulations. More specifically, for example, the simulation information collection unit 603 may output the simulation information including all the performance values at a time when the target CPU 101 has executed the target programs pgr by summing the performance values of the blocks BB.

### Example of Procedure of Simulation Process Performed by Simulation Apparatus 100

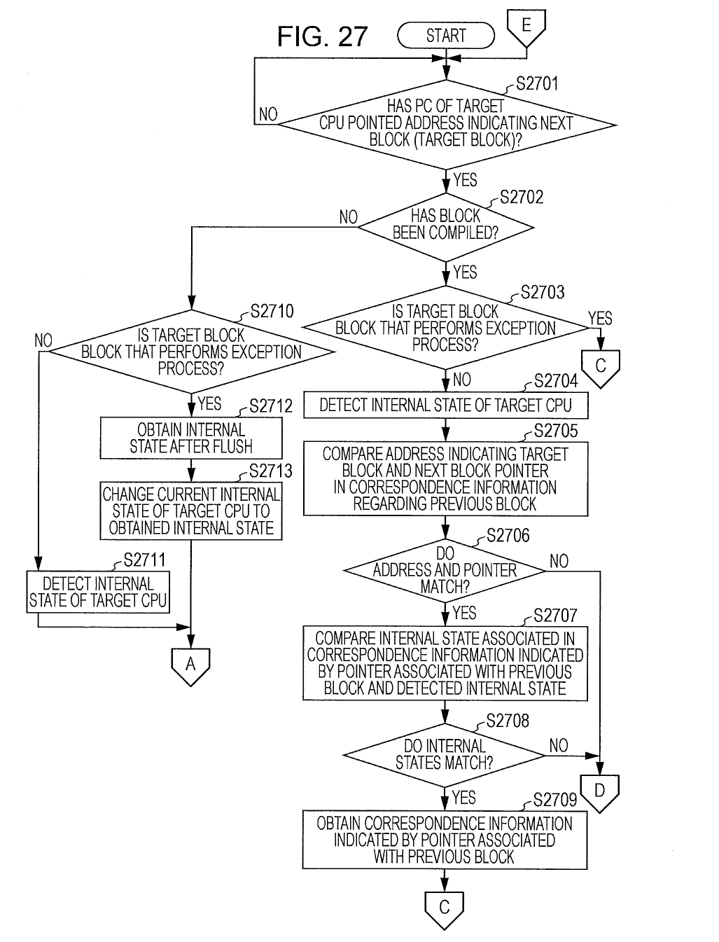

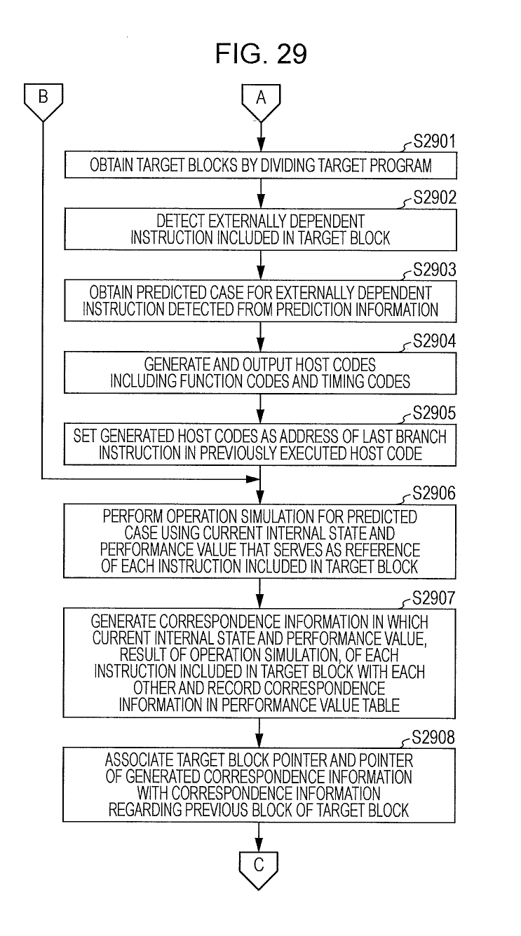

FIGS. 27 to 29 are diagrams illustrating an example of an operational flowchart for a simulation process performed by a simulation apparatus, according to an embodiment. First, the simulation apparatus 100 determines whether the PC 1201 of the target CPU 101 has pointed an address indicating the next block (target block) (step S2701). The simulation apparatus 100 determines in step S2701 whether the target block has changed.

When the PC 1201 of the target CPU 101 has not pointed an address indicating the next block (target block) (NO in step S2701), the simulation apparatus 100 returns the process to step S2701. On the other hand, when the PC 1201 of the target CPU 101 has pointed an address indicating the next block (target block) (YES in step S2701), the simulation apparatus 100 determines whether the target block has been compiled (step S2702). When the simulation apparatus 100 has determined that the target block has been compiled (YES in step S2702), the simulation apparatus 100 determines whether the target block is a block that performs the exception process (step S2703).

When the simulation apparatus 100 has determined that the target block is a block that performs the exception process (YES in step S2703), the simulation apparatus 100 causes the process to proceed to step S2807. When the simulation apparatus 100 has determined that the target block is not a block that performs the exception process (NO in step S2703), the simulation apparatus 100 detects the internal state of the target CPU 101 (step S2704). Here, the detected internal state is the internal state after the completion set in the correspondence information used for executing the host codes hc corresponding to the previous target block. When there is no previous target block (in the case of the initial block), the detected internal state is the initial state of the target CPU 101. The simulation apparatus 100 compares the address indicating the target block and the pointer of the next block in the correspondence information 2101 regarding the previous block (step S2705). The address indicating the target block is an address indicating a storage region storing the host codes hc of the target block.

The simulation apparatus 100 determines whether the address indicating the target block and the pointer of the next block in the correspondence information 2101 regarding the previous block match (step S2706). When the simulation apparatus 100 has determined that the address and the pointer match (YES in step S2706), the simulation apparatus 100 compares the internal state associated in the correspondence information 2101 indicated by the pointer associated with the previous block and the detected internal state (step S2707). The simulation apparatus 100 then determines whether the internal state associated in the correspondence information 2101 indicated by the pointer associated with the previous block and the detected internal state match (step S2708). When the internal states match (YES in step S2708), the simulation apparatus 100 obtains the correspondence information 2101 indicated by the pointer associated with the previous block (step S2709) and causes the process to proceed to step S2807.

On the other hand, when the simulation apparatus 100 has determined in step S2706 that the address and the pointer do not match (NO in step S2706) or when the simulation apparatus 100 has determined in step S2708 that the internal states do not match (NO in step S2708), the simulation apparatus 100 causes the process to proceed to step S2801.

The simulation apparatus 100 determines whether there is an unselected internal state among the internal states associated in the correspondence information 2101 registered to the performance value table TT regarding the target block (step S2801). When there is no unselected internal state (NO in step S2801), the simulation apparatus 100 causes the process to proceed to step S2906. As a result, the correspondence information 2101 is generated for each internal state detected for the target block, and the host codes hc are generated only once for the target block.

When there is an unselected internal state (YES in step S2801), the simulation apparatus 100 selects one of unselected internal states registered earliest (step S2802). The simulation apparatus 100 compares the detected internal state and the selected internal state (step S2803). The simulation apparatus 100 then determines whether the internal states match (step S2804). When the simulation apparatus 100 has determined that the internal states match (YES in step S2804), the simulation apparatus 100 obtains, from the performance table TT, the correspondence information 2101 in which the selected internal state is associated (step S2805).

The simulation apparatus 100 associates the pointer of the target block and the pointer of the obtained correspondence information with the correspondence information 2101 regarding the previous block of the target block (step S2806). The simulation apparatus 100 then performs a process for executing the host codes hc using the obtained correspondence information 2101 (step S2807) and returns the process to step S2701. On the other hand, when the simulation apparatus 100 has determined that the internal states do not match (NO in step S2804), the simulation apparatus 100 returns the process to step S2801.

When the simulation apparatus 100 has determined that the target block has not been compiled (NO in step S2702), the simulation apparatus 100 determines whether the target block is a block that performs the exception process (step S2710). When the simulation apparatus 100 has determined that the target block is not a block that performs the exception process (NO in step S2710), the simulation apparatus 100 detects the internal state of the target CPU 101 (step S2711) and causes the process to proceed to step S2901. When the simulation apparatus 100 has determined that the target block is a block that performs the exception process (YES in step S2710), the simulation apparatus 100 obtains the internal state after a flush (step S2712). The simulation apparatus 100 then changes the current internal state of the target CPU 101 in the operation simulation sim to the obtained internal state (step S2713) and causes the process to proceed to step S2901.

The simulation apparatus 100 obtains target blocks by dividing the target program pgr (step S2901). Here, the simulation apparatus 100 obtains instructions from the target program pgr. The simulation apparatus 100 then divides the target program by analyzing the instructions to determine whether the instructions are branch instructions or instructions in which an exception might occur. The simulation apparatus 100 detects an externally dependent instruction included in the target block (step S2902) and obtains a predicted case of the detected externally dependent instruction from the prediction information 641 (step S2903). The simulation apparatus 100 generates and outputs host codes hc including function codes fc obtained by compiling the target block and timing codes tc that is able to calculate the performance value of the target block in the predicted case based on the correspondence information 2101 (step S2904). The performance value of the target block in the predicted case is the performance value of the target block at a time when the detected externally dependent instruction has resulted in the obtained predicted case.

Next, the simulation apparatus 100 sets the generated host codes hc as the address of a last branch instruction of a previously executed host code hc (step S2905). The simulation apparatus 100 then performs the operation simulation sim for the predicted case using the current internal state and the performance values that serve as references of instructions included in the target block (step S2906). Here, the current internal state is the detected internal state or the specific internal state SF. The simulation apparatus 100 generates correspondence information 2101 in which the current internal state and the performance values, which are results of the operation simulation sim, of the instructions included in the target block are associated with each other, and records the correspondence information 2101 in the performance value table TT (step S2907). The simulation apparatus 100 then associates the pointer of the target block and the pointer of the generated correspondence information 2101 with each other in the correspondence information 2101 regarding the previous block of the target block (step S2908) and causes the process to proceed to step S2807. The correspondence information 2101 regarding the previous block of the target block is the correspondence information 2101 used for calculating the performance value of the previous block of the target block.

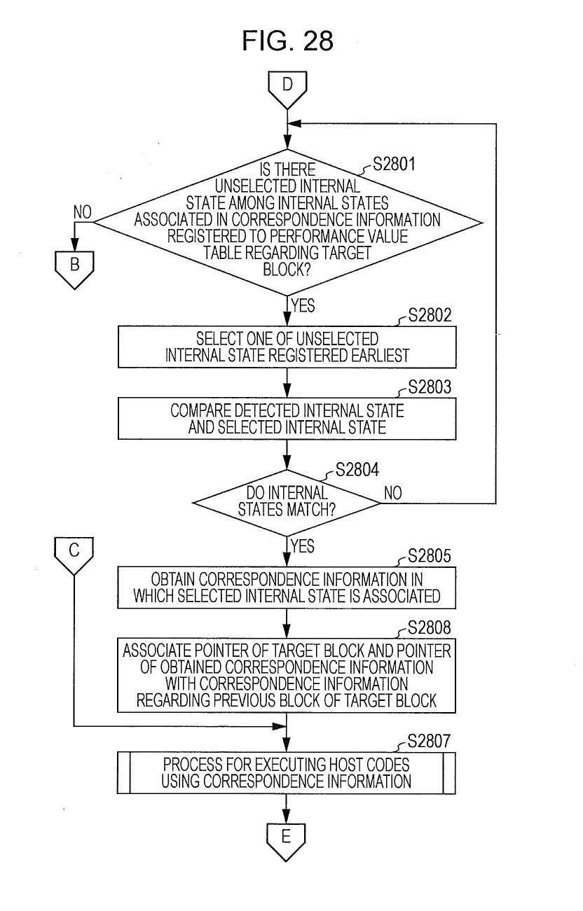

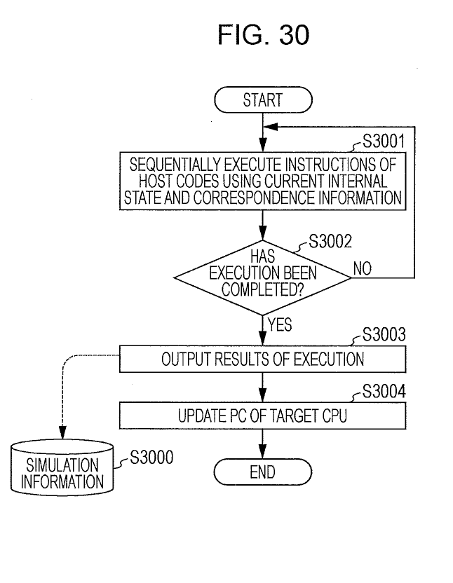

FIG. 30 is a diagram illustrating an example of an operational flowchart for a process of executing host codes, according to an embodiment, which is indicated by step S2807 of FIG. 28. First, the simulation apparatus 100 sequentially executes the instructions of the host codes hc using the current internal state and the correspondence information (step S3001). The simulation apparatus 100 determines whether the execution has been completed (step S3002). When the simulation apparatus 100 has determined that the execution has not been completed (NO in step S3002), the simulation apparatus 100 returns the process to step S3001. When the simulation apparatus 100 has determined that the execution has been completed (YES in step S3002), the simulation apparatus 100 outputs results of the execution (step S3003). For example, the results of the execution are stored in a storage device such as the RAM 503 or the disk 505 as simulation information 3000. The simulation apparatus 100 updates the PC 1201 of the target CPU 101 in the operation simulation sim (step S3004) and ends the series of processes.

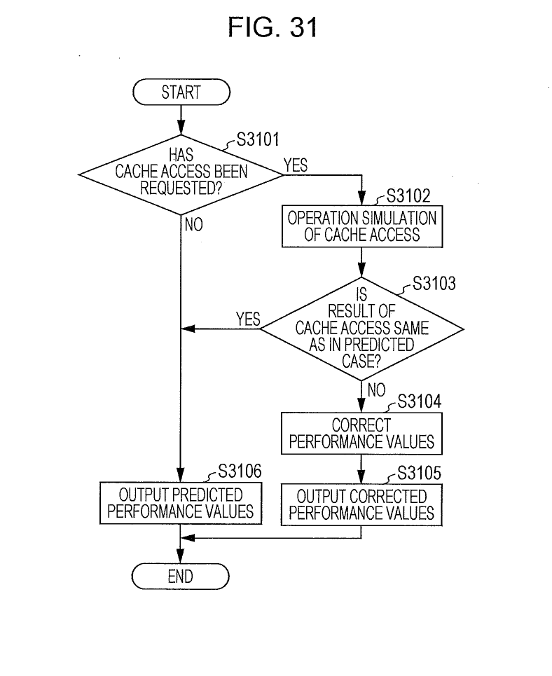

FIG. 31 is a diagram illustrating an example of an operational flowchart for a correction process performed by a correction unit, according to an embodiment. The correction unit 632 illustrated in FIG. 6 is a helper function module. In the following description, a helper function as to whether a result of cache access by an Id instruction is a “hit” will be taken as an example.

First, the simulation apparatus 100 determines whether cache access has been requested (step S3101). When cache access has not been requested (NO in step S3101), the simulation apparatus 100 causes the process to proceed to step S3106. When cache access has been requested (YES in step S3101), the simulation apparatus 100 performs an operation simulation of the cache access (step S3102). As described above, here, the operation simulation is a simple simulation using a system model including a host CPU and a cache memory. The simulation apparatus 100 then determines whether a result of the cache access in the operation simulation is the same as in the predicted case (step S3103).

When the simulation apparatus 100 has determined that the results are not the same (NO in step S3103), the simulation apparatus 100 corrects the performance values (step S3104). The simulation apparatus 100 then outputs the corrected performance values (step S3105) and ends the process. When the simulation apparatus 100 has determined that the results are the same (YES in step S3103), the simulation apparatus 100 outputs the predicted performance values included in the correspondence information (step S3106) and ends the process.

As described above, when the target block is a block that performs the process according to an exception, the simulation apparatus 100 simulates the operation at a time when the target CPU 101 has executed the target block after the internal state of the target CPU 101 is flushed. As a result, a simulation of an operation closer to the operation of the target CPU 101 may be performed, thereby improving the accuracy of estimating the performance of the processor.

In addition, the specific internal state refers to a state in which the target CPU 101 has been subjected to a pipeline flush. Therefore, the performance of the processor may be estimated more accurately.

In addition, when the simulation apparatus 100 has determined that the target block has changed from the first block to the second block and the second block was not a target block in the past, the simulation apparatus 100 generates execution codes that are able to calculate, based on the internal state and the correspondence information, the performance value at a time when the target block has been executed. On the other hand, when the simulation apparatus 100 has determined that the second block was a target block in the past, the simulation apparatus 100 does not generate execution codes. As a result, the execution codes are generated only once, thereby reducing the amount of memory used.

In addition, when the simulation apparatus 100 has determined that the second block was a target block in the past and is a block that performs the process according to an exception, the simulation apparatus 100 does not generate correspondence information. As a result, correspondence information regarding a block that performs the process according to an exception is generated only once, thereby reducing the amount of memory used.

In addition, when the simulation apparatus 100 has determined that the second block is not a block that performs the process according to an exception, the simulation apparatus 100 detects the internal state of the processor in the operation simulation. The simulation apparatus 100 then executes an operation simulation of the target block to generate correspondence information in which the detected internal state and the performance value of the target block in the detected internal state are associated with each other. As a result, the accuracy of estimating the performance of the target CPU 101 improves.

The simulation method described in the embodiment may be realized by executing a simulation program prepared in advance using a computer such as a personal computer or a work station. The simulation program is recorded on a computer-readable recording medium such as a magnetic disk, an optical disk, a Universal Serial Bus (USB) flash memory, and executed when read from the recording medium by a computer. In addition, the simulation program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method for simulating an operation of a processor with out-of-order execution, the method being performed by a computer configured to access a storage unit storing a specific internal state of the processor, the method comprising:
dividing a program executed by the processor into a plurality of blocks;
determining, when a target block on which an operation simulation is to be performed is changed from a first block to a second block in the plurality of blocks, whether the second block is a block that performs a process according to an exception that has occurred in the first block; and
performing, when it is determined that the second block is a block that performs the process according to the exception, the operation simulation of the second block after changing an internal state of the processor in the operation simulation to the specific internal state stored in the storage unit.

2. The method of claim 1, further comprising:
generating first correspondence information in which the specific internal state and performance values of instructions included in the second block in the specific internal state are associated with each other; and
calculating a performance value at a time when the processor executes the second block, by executing, using the specific internal state and the second correspondence information generated for the second block, an execution code configured to:
calculate, based on second correspondence information in which an internal state and performance values are associated with each other, the performance value at a time when the processor executes the second block, and
correct the performance values associated with the internal state in the second correspondence information in accordance with a simulation of an operation of a cache memory that is accessible by the processor at a time when the processor executes an access instruction, included in the second block, for causing the processor to access a storage region.

3. The method of claim 1, wherein
the specific internal state is a state in which pipelines of the processor have been flushed.

4. The method of claim 2, further comprising:
determining, when a target block has changed from the first block to the second block, whether the second block was not a target block in past; and
generating the execution code when it is determined that the second block was a target block in past, and not generating the execution code when it is determined that the second block was a target block in past, wherein,
in the calculating the performance value, the generated execution code is executed.

5. The method of claim 4, wherein
when it is determined that the second block was a target block in the past and is a block that performs the process according to an exception, the generating the correspondence information is not performed; and,
in the calculating the performance value, the execution code is executed using the second correspondence information that has been previously generated.

6. The method of claim 1, further comprising:
when it is determined that the second block is not a block that performs the process according to an exception, performing a process including:
detecting, an internal state of the processor in the operation simulation;
generating, by executing the operation simulation of the target block, correspondence information in which the detected internal state and a performance value of the target block in the detected internal state are associated with each other; and
calculating the performance value at a time when the processor executes the target block, by executing, using the specific internal state and the correspondence information generated for the target block, an execution code configured to calculate, based on the generated correspondence information, a performance value at a time when the processor executes the target block.

7. An apparatus for simulating an operation of a first processor with out-of-order execution, the apparatus comprising:
a storage unit configured to store a specific internal state of the first processor; and
a second processor that is different from the first processor, wherein the second processor is configured to:
divide a program executed by the processor into a plurality of blocks,
determine, when a target block on which an operation simulation is to be performed is changed from a first block to a second block in the plurality of blocks, whether the second block is a block that performs a process responsive to an exception that has occurred in the first block, and
perform, when it is determined that the second block is a block that performs the process responsive to the exception, the operation simulation of the second block after changing an internal state of the processor in the operation simulation to the specific internal state stored in the storage unit.

8. A non-transitory, computer-readable recording medium having stored therein a simulation program for causing a computer to execute a process, the computer being configured to access a storage unit storing a specific internal state of a processor with out-of-order execution, the process comprising:
dividing a program executed by the processor into a plurality of blocks;
determining, when a target block on which an operation simulation is to be performed is changed from a first block to a second block in the plurality of blocks, whether the second block is a block that performs a process responsive to an exception that has occurred in the first block; and
performing, when it is determined that the second block is a block that performs the process responsive to the exception, the operation simulation of the second block after changing an internal state of the processor in the operation simulation to the specific internal state stored in the storage unit.
